(19) United States
(12) Patent Application Publication
(10) Pub. No.: US 2011/0139474 A1
(43) Pub. Date: Jun. 16, 2011

(54) PNEUMATIC IMPACT TOOL

(76) Inventors: Warren Andrew Seith, Bethlehem, PA (US); Lucas James Taylor, Easton, PA (US); Randi Jane Young, Randolph, NJ (US); Nathanael S. Murphy, Colorado Springs, CO (US)

(21) Appl. No.: 13/033,217

(22) Filed: Feb. 23, 2011

Related U.S. Application Data
(63) Continuation-in-part of application No. 12/115,161, filed on May 5, 2008.
Application No. 12/115,161 is a continuation-in-part of application No. 12/914,076, filed on Oct. 28, 2010.
Application No. 12/914,076 is a continuation of application No. 12/115,172, filed on May 5, 2008, now Pat. No. 7,886,840.

(51) Int. Cl. B25B 21/02; B23B 45/16

(52) U.S. Cl. 173/93; 173/218; 173/216

(57) ABSTRACT

A pneumatic impact tool includes a handle, a work attachment coupled to the handle, an inlet and an outlet permitting air flow through the tool to drive the tool. A motor assembly is functionally positioned between the inlet and the outlet, the motor assembly having a rotor driven by the air flow, and the motor assembly defining a longitudinal motor axis about which the rotor rotates. An output drive is connected to the motor assembly to selectively rotate the output drive in response to rotation of the rotor. The output drive defines a longitudinal output axis about which the output drive rotates, such that the longitudinal output axis is substantially perpendicular to the longitudinal motor axis. An impact mechanism is functionally positioned between the motor assembly and the output drive, such that the impact mechanism drives the output drive with impact forces in response to rotation of the rotor.

### CROSS-REFERENCE TO RELATED APPLICATIONS

The present application is a continuation-in-part of U.S. patent application Ser. No. 12/115,161, filed May 5, 2008, and is a continuation-in-part of U.S. patent application Ser. No. 12/914,076, filed Oct. 28, 2010, which is a continuation of Ser. No. 12/115,172, filed May 5, 2008, the entire contents of all of which are herein incorporated by reference.

### FIELD OF THE INVENTION

The present invention relates to gear arrangements for pneumatic impact tools.

### SUMMARY

In one embodiment, the invention provides a pneumatic impact tool includes a handle assembly, a work attachment coupled to the handle assembly, an inlet and an outlet permitting air flow through the tool to drive the tool. The tool further includes a motor assembly functionally positioned between the inlet and the outlet, the motor assembly having a rotor driven by the air flow, and the motor assembly defining a longitudinal motor axis about which the rotor rotates. An output drive is connected to the motor assembly to selectively rotate the output drive in response to rotation of the rotor. The output drive defines a longitudinal output axis about which the output drive rotates, such that the longitudinal output axis is substantially perpendicular to the longitudinal motor axis. An impact mechanism is functionally positioned between the motor assembly and the output drive, such that the impact mechanism drives the output drive with impact forces in response to rotation of the rotor.

In another embodiment, the invention provides a pneumatic impact tool having a handle assembly graspable by a user, a work attachment connected to the handle assembly, an inlet permitting air flow into the pneumatic impact tool to drive the impact tool, and an outlet permitting air flow out of the pneumatic impact tool. A motor assembly is functionally positioned between the inlet and the outlet, the motor assembly includes a rotor driven by the air flow between the inlet and the outlet, and the motor assembly defines a longitudinal motor axis about which the rotor rotates. A valve is connected to the handle assembly, the valve is moveable between a first position, in which the rotor is rotated in a first direction, and a second position, in which the rotor is rotated in a second direction, opposite the first direction. An output drive is connected to the motor assembly and selectively rotates in response to rotation of the rotor. The output drive defines a longitudinal output axis about which the output drive rotates, such that the longitudinal output axis is substantially perpendicular to the longitudinal motor axis. An impact mechanism is functionally positioned between the motor assembly and the output drive, such that the impact mechanism drives the output drive with impact forces in response to rotation of the rotor.

In yet another embodiment, the invention provides a pneumatic impact tool including a handle assembly graspable by a user, a work attachment connected to the handle assembly, an inlet permitting air flow into the pneumatic impact tool to drive the impact tool, and an outlet permitting air flow out of the pneumatic impact tool. A motor assembly is functionally positioned between the inlet and the outlet. The motor assembly includes a rotor driven by the air flow between the inlet and the outlet, and the motor assembly defines a longitudinal motor axis about which the rotor rotates. A valve is connected to the handle assembly. The valve is moveable between a first position, in which the rotor is rotated in a first direction, and a second position, in which the rotor is rotated in a second direction, opposite the first direction. The valve has a detent mechanism resiliently holding the valve in the first and second positions. An output drive is connected to the motor assembly and selectively rotates in response to rotation of the rotor. The output drive defines a longitudinal output axis about which the output drive rotates, wherein the longitudinal output axis is substantially perpendicular to the longitudinal motor axis. An impact mechanism is functionally positioned between the motor assembly and the output drive, the impact mechanism selectively driving the output drive in response to rotation of the rotor, the impact mechanism comprising a hammer coupled to the rotor for rotation with the rotor, and an anvil coupled to the output drive, the hammer operable to impact the anvil to drive the output drive with impact forces in response to rotation of the rotor.

Other aspects of the invention will become apparent by consideration of the detailed description and accompanying drawings.

### BRIEF DESCRIPTION OF THE DRAWINGS

FIG. 1 is a perspective view of a pneumatic tool embodying the invention.

FIG. 2 is an exploded view of the handle assembly of the tool.

FIG. 3 is an enlarged perspective view of a motor cylinder of the handle assembly.

FIG. 4A is a rear perspective view of a rotary valve of the handle assembly.

FIG. 4B is a front perspective view of the rotary valve.

FIG. 5 is a cross-sectional view of the rotary valve taken along line 5-5 in FIG. 4A.

FIG. 6 is a cross-sectional view of the tool taken along line 6-6 in FIG. 1.

FIG. 7 is a cross-sectional view taken along line 7-7 in FIG. 6.

FIG. 8 is a cross-sectional view taken along line 8-8 in FIG. 6.

FIG. 9 is an enlarged view of the portion encircled in FIG. 8.

FIG. 10 is a cross-sectional view of the tool taken along line 10-10 in FIG. 1.

FIG. 11 is a cross-sectional view of the tool taken along line 11-11 in FIG. 1, with the rotary valve in a forward power reduction position.

FIG. 12 is an enlarged view of the left end of the drawing of FIG. 7.

FIG. 13 is a cross-sectional view of the tool according to another embodiment of the invention.

FIG. 14 is a cross-sectional view of the tool according to another embodiment of the invention.

FIG. 15 is a cross-sectional view of the tool according to another embodiment of the invention.

FIG. 16 is an enlarged view of a portion of the tool according to another embodiment of the invention.

FIG. 17 is an exploded perspective view of the angle head of the pneumatic tool of FIG. 1.

FIG. 18 is a cross-sectional view of the angle head taken along line 18-18 of FIG. 1.

FIG. 19 is a front view of a bevel gear blank according to an embodiment of the invention.

FIG. 20 is a front view of a bevel gear according to an embodiment of the invention.

FIGS. 21A-21I illustrate an impact cycle of one embodiment of the pneumatic impact tool.

FIG. 22 is an exploded view of an alternate embodiment of an angle head of an impact tool.

FIG. 23 is a cross-sectional view taken along line 23-23 of FIG. 22.

FIGS. 24A-24J illustrate an impact cycle of the impact tool of FIGS. 22 and 23.

FIG. 25 is an exploded view of another alternate embodiment of an angle head of an impact tool.

FIG. 26 is a cross-sectional view taken along line 26-26 of FIG. 25.

FIG. 27 is a top view of a pneumatic impact tool to show relative height, thickness, width of head and motor.

FIG. 28 is a bottom view of the pneumatic impact tool.

FIG. 29 is a left side view of the pneumatic impact tool.

FIG. 30 is a right side view of the pneumatic impact tool.

FIG. 31 is a rear view of the pneumatic impact tool.

FIG. 32 is a front view of the pneumatic impact tool.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

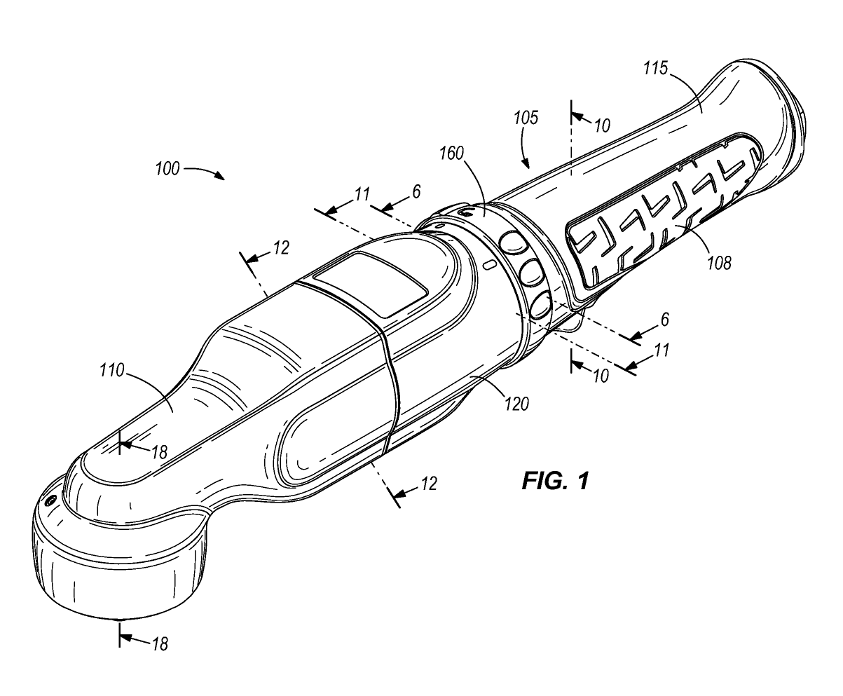

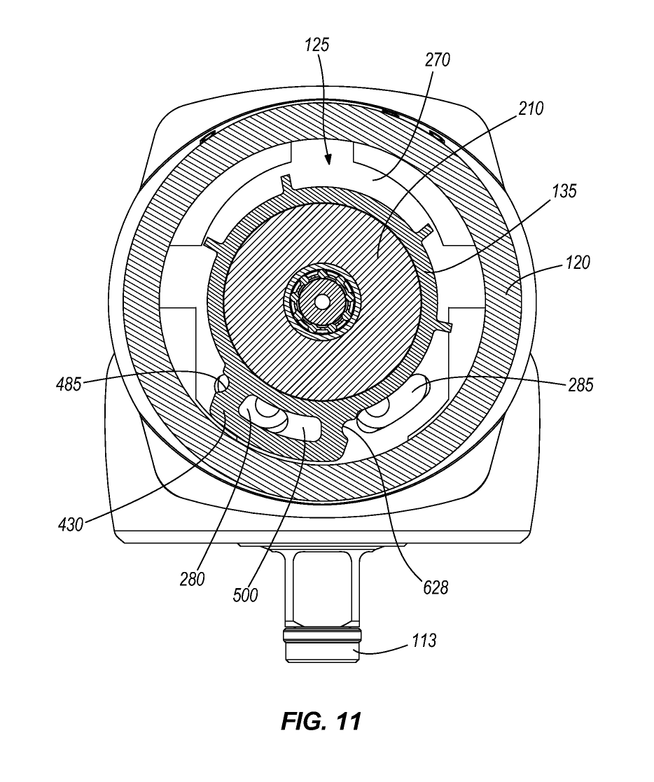

FIG. 1 illustrates a pneumatic tool 100 that includes a handle or motor assembly 105 and a work attachment 110. The illustrated work attachment 110 is an angle head with a square drive 113 (see FIGS. 6 and 11) to which a socket or other fastener-driving output element may be connected, but may in other constructions be substantially any tool adapted to be driven by a rotating output shaft of the motor assembly, including but not limited to an impact wrench, gear reducer, and the like.

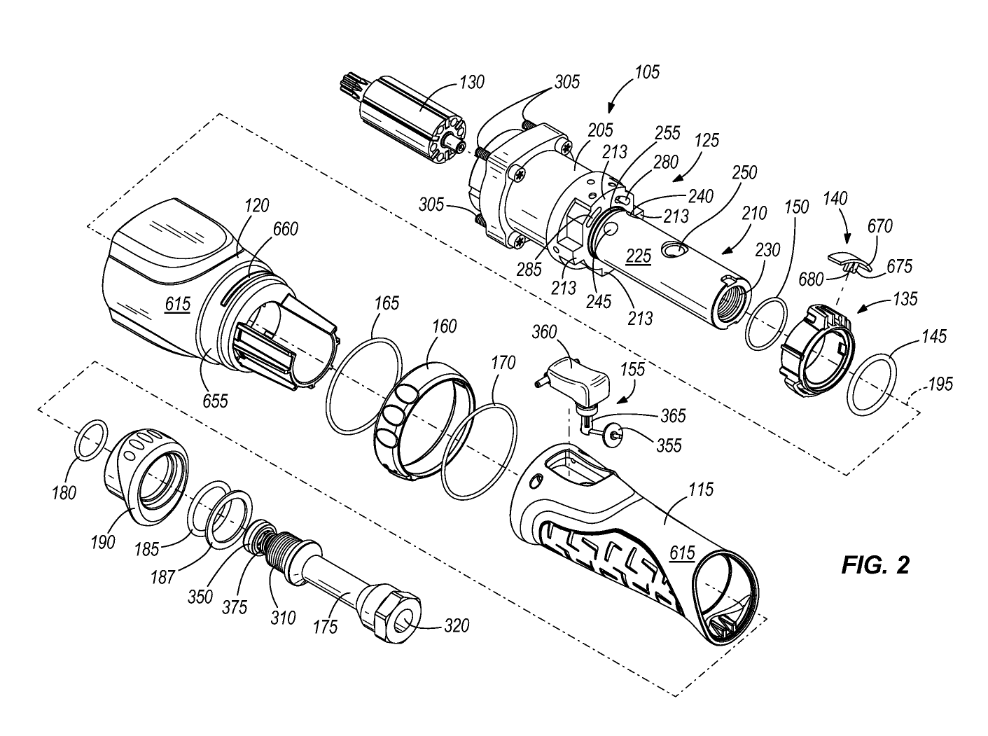

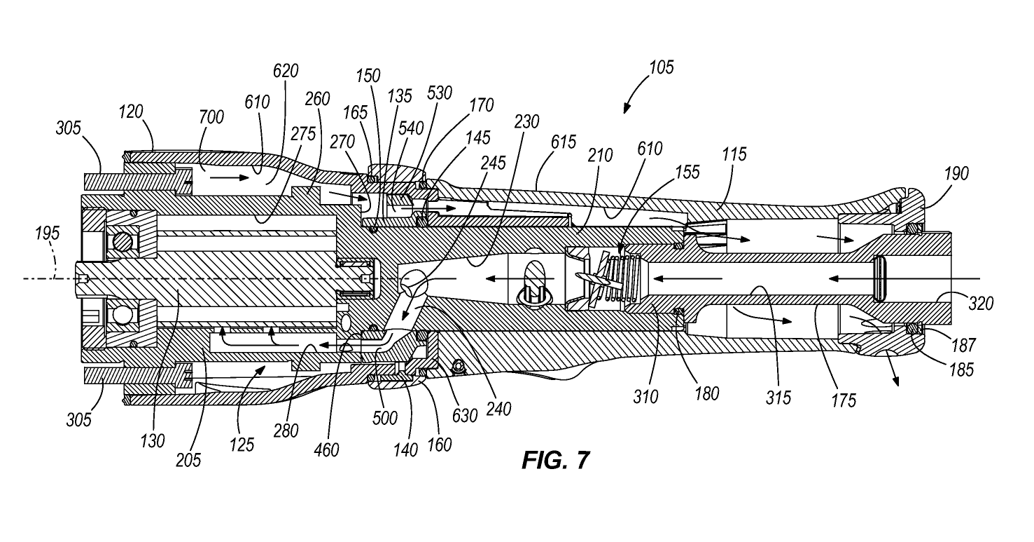

With reference to FIG. 2, the handle assembly 105 has a handle grip portion 108 and includes a rear housing 115, a front housing 120, a motor cylinder 125, a motor rotor 130, a rotary valve 135, a valve actuator 140, first and second valve seals 145, 150, a throttle mechanism 155, a ring 160, first and second ring seals 165, 170, an inlet bushing 175, first and second inlet seals 180, 185, an inlet washer 187 and an exhaust cap 190, along with other parts, subparts, and aspects that will be identified later. The front and rear housings 120, 115 cooperate to define an outer housing having an internal cavity in which the majority of the other elements of the handle or motor assembly 105 are housed. The handle assembly 105 includes a handle or motor longitudinal axis 195 (also called the “main axis” in this description, see also FIG. 7), and the motor cylinder 125, motor rotor 130, rotary valve 135, inlet bushing 175, and exhaust cap 190 are arranged along the handle longitudinal axis within the internal cavity of the outer housing 120, 115.

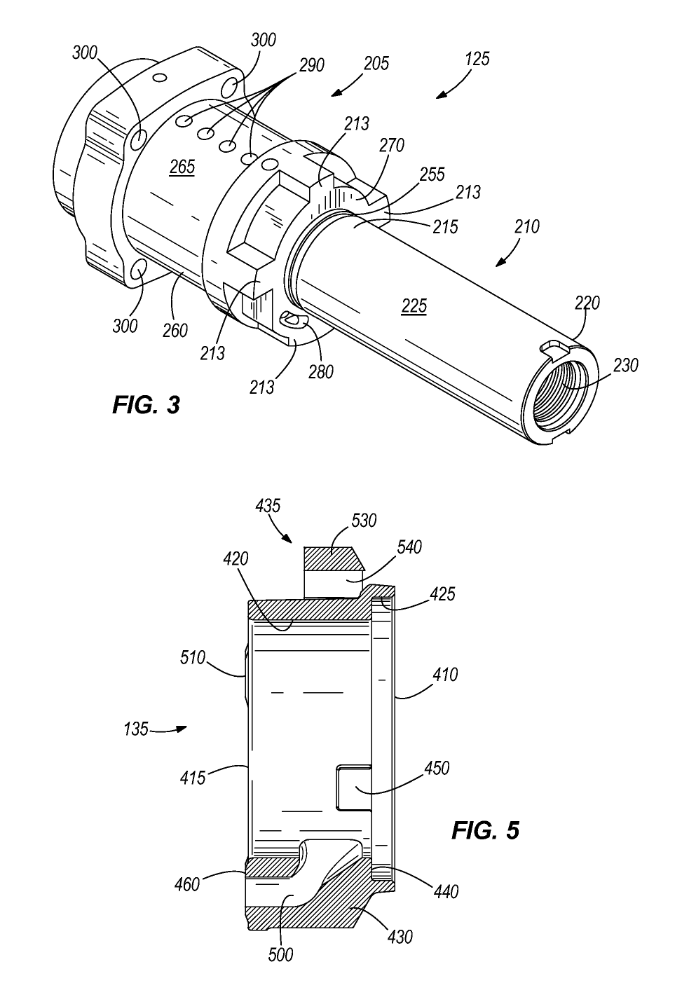

FIGS. 2 and 3 illustrate the motor cylinder 125, which includes a motor chamber portion 205 and an inlet conduit portion 210 integrally formed as a single piece. In the illustrated embodiment, the motor chamber portion 205 and inlet conduit portion 210 are generally cylindrical in shape. Four housing support projections 213 are integrally formed in the motor chamber portion 205 at the junction with the inlet conduit portion 210.

The motor chamber portion 205 includes a motor chamber longitudinal axis that is collinear with the main axis 195, and the inlet conduit portion 210 includes an inlet longitudinal axis or inlet axis that is also collinear with the main axis 195. The motor chamber portion 205 has a larger diameter than the inlet conduit portion 210. In other embodiments, the motor chamber portion 205 and inlet conduit portion 210 may be shaped other than illustrated.

The inlet conduit portion 210 includes a proximal end 215 integrally formed with the motor chamber portion 205 at a junction, an opposite distal end 220, and an exterior surface 225 extending between the proximal and distal ends 215, 220. An inlet passage 230 communicates with the distal end 220 (where it includes internal threads, as illustrated), extends substantially the entire length of the inlet conduit portion 210, and terminates at the proximal end 215. As used herein, a passage or port is said to “communicate” with or through a structure (e.g., the distal end 220 in the case of the inlet passage 230 or the exterior surface 225 or other surface in the case of other passages and ports described below) when it defines an aperture in the structure, and is said to communicate with another passage or port when it permits fluid flow into the other passage or port. The inlet passage 230 extends along and has a longitudinal axis collinear with the main axis 195. Communicating with the inlet passage 230 through the exterior surface 225 are a forward port 240, a reverse port 245, and a throttle port 250. A seal seat 255 is formed in and extends around the entire outer diameter of the exterior surface 225 of the inlet conduit portion 210 near the proximal end 215.

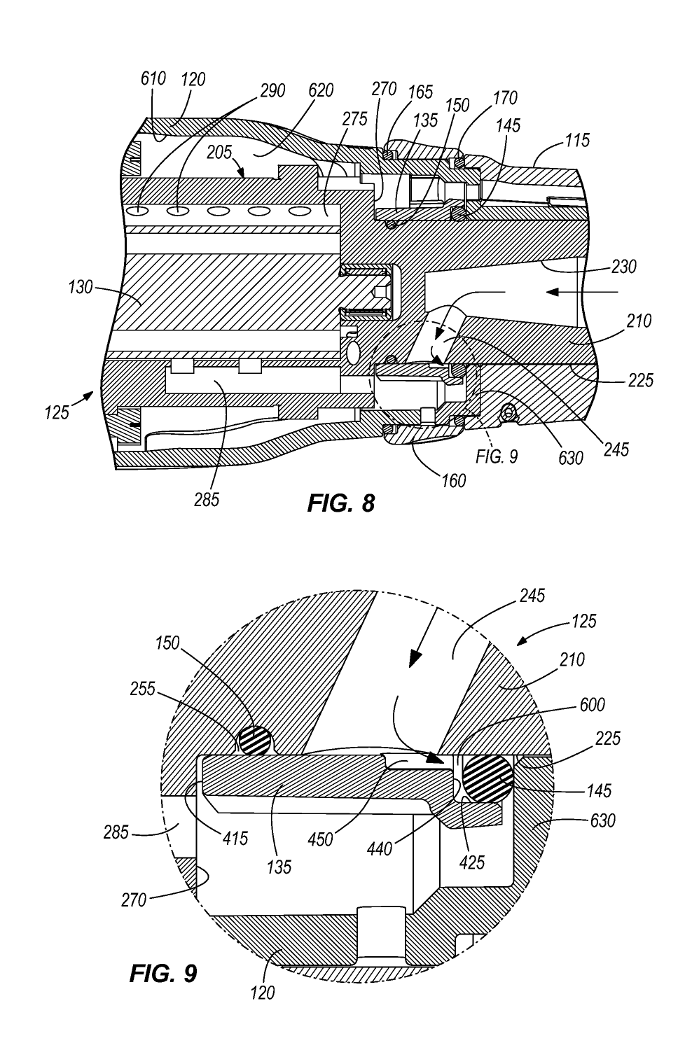

The motor chamber portion 205 of the motor cylinder 125 includes a motor chamber wall 260 that has an exterior surface 265 and that defines a first substantially planar surface 270 extending radially away from the proximal end 215 of the inlet conduit portion 210 at the junction. The first planar surface 270 surrounds the proximal end 215 and is consequently generally ring-shaped. The motor chamber wall 260 also defines a motor chamber 275 (FIGS. 7 and 8) in which the motor rotor 130 is supported for rotation about a rotor axis that is collinear with the main axis 195. Formed in the motor chamber wall 260 are a forward supply passage 280, a reverse supply passage 285, and a plurality of exhaust ports 290. The forward and reverse supply passages 280, 285 communicate between the first planar surface 270 and the motor chamber 275, and the exhaust ports 290 communicate between the motor chamber 275 and the exterior surface 265 of the motor chamber portion 205. The end of the motor chamber portion 205 opposite the first planar surface 270 has a plurality of cylinder mounting holes 300 that receive a plurality of fasteners 305 for securing the work attachment 110 to the motor cylinder 125. In this regard, the end of the motor chamber portion 205 acts as a mounting flange.

With reference to FIGS. 2 and 7, the inlet bushing 175 includes external threads 310 at one end that thread into the internal threads of the inlet passage 230 at the distal end 220 of the inlet conduit portion 210. The first inlet seal 180 provides a seal between the inlet conduit portion 210 and the inlet bushing 175. At the end opposite the external threads 310, the inlet bushing 175 is sealed within the exhaust cap 190 with the second inlet seal 185. The inlet bushing 175 defines a bushing passage 315 that communicates with the inlet passage 230. The inlet bushing 175 and bushing passage 315 define a bushing longitudinal axis that is collinear with the main 195. The inlet bushing 175 provides a fitting 320 that is adapted to mate with a fitting on a source of motive fluid (e.g., the outlet fitting on a supply hose providing compressed air, nitrogen, or another compressible fluid) supplied under pressure from a source, and conduct the motive fluid through the bushing passage 315 to the inlet passage 230. The inlet conduit portion 210, inlet passage 230, inlet bushing 175, and bushing passage 315 include longitudinal axes that are parallel to and substantially collinear with the main axis 195.

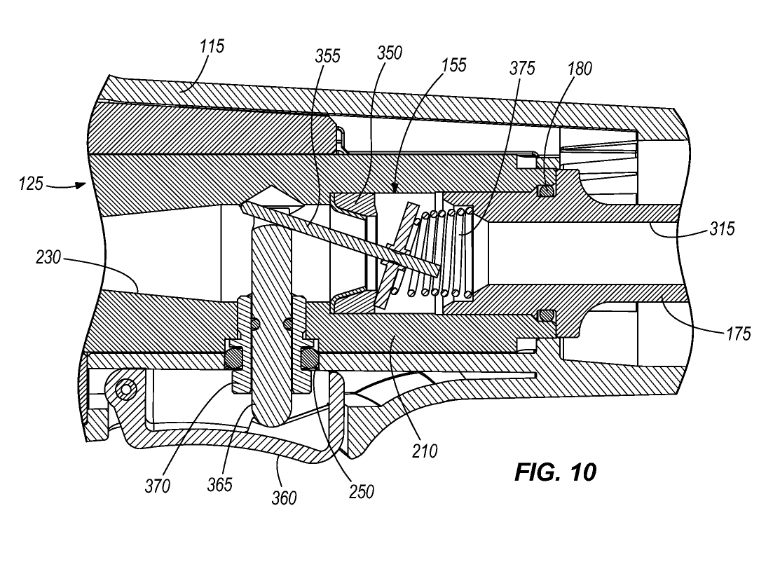

With reference to FIGS. 2 and 10, the throttle mechanism 155 includes a throttle seat 350 in a reduced-diameter portion of the inlet passage 230, and a “tip” style valve 355 that sits in the throttle seat 350. The throttle mechanism 155 also includes a trigger 360 mounted to the rear housing 115, and a throttle pin or actuator 365 extending between the trigger 360 and tip style valve 355 through a throttle bushing 370 in the throttle port 250. The throttle bushing 370 provides a seal around the throttle actuator 365 to resist the escape of motive fluid from the inlet passage 230 through the throttle port 250. The throttle actuator 365 moves linearly in the throttle bushing 370 in response to actuation of the trigger 360, and tips the tip style valve 355 with respect to the throttle seat 350, which opens communication between the bushing passage 315 and the inlet passage 230. When the tip style valve 355 is open, a pressurized supply of motive fluid rushes into the inlet passage 230 to drive operation of the tool 100. When the trigger 360 is released, the pressurized motive fluid, assisted by a spring 375, causes the tip style valve 355 to automatically re-seat itself and shut off the flow of motive fluid into the inlet passage 230.

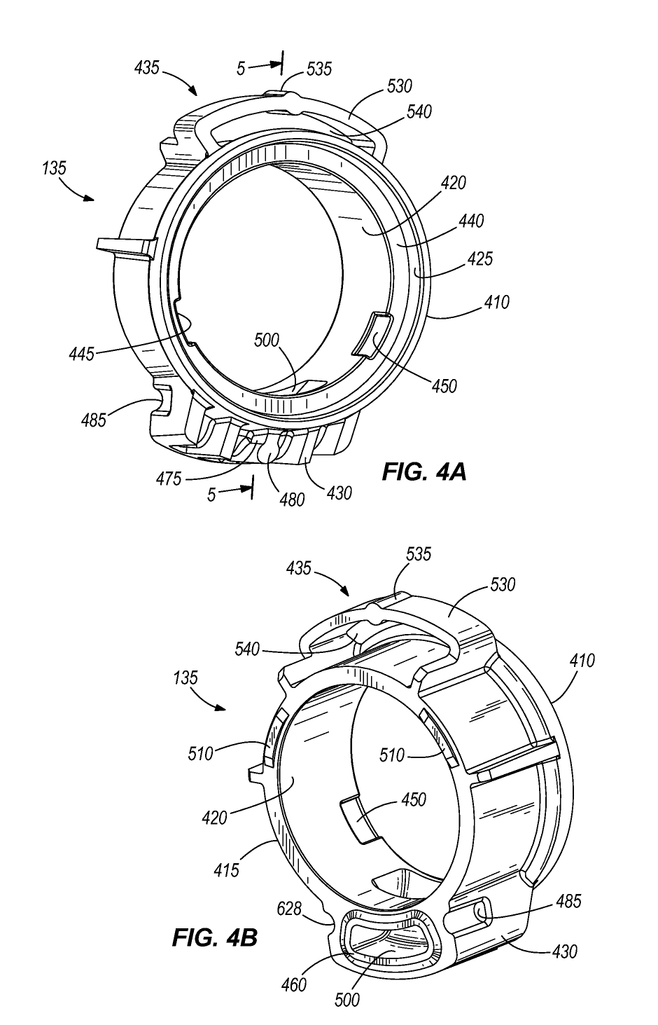

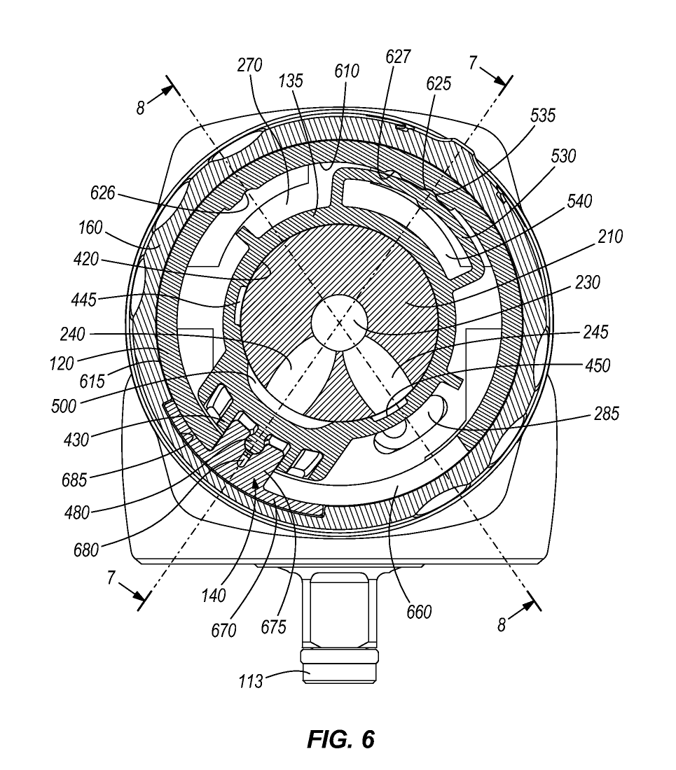

FIGS. 4A, 4B, and 5 illustrate the rotary valve 135, which is generally ring-shaped, and which includes first and second ends 410, 415, a primary bore 420 extending between the first and second ends 410, 415, a counter bore 425 in the first end 410, an enlarged structural portion 430, and a resilient deflectable member 435. The entire rotary valve 135 is integrally formed as a single integral part in the illustrated embodiment.

A ring-shaped pressure biasing surface 440 is defined by the step between the primary bore 420 and the counter bore 425 at the first end 410. Forward and reverse undercuts or open channels 445, 450 in the primary bore 420, acting in conjunction with the exterior surface 225 of the inlet conduit portion 210 when assembled, define forward and reverse biasing passages that intersect the pressure biasing surface 440.

The enlarged structural portion 430 defines a second planar surface 460 at the second end 415 of the rotary valve 135, a mounting finger 475 with an enlarged head 480, and a forward power reduction (“FPR”) port or groove 485. Extending through the enlarged structural portion 430 is a valve passage 500. The valve passage 500 communicates between the primary bore 420 and the second planar surface 460. A pair of stabilizing protrusions 510 are provided in the second end 415 of the rotary valve 135, and provide flat surfaces that are co-planar with each other and with the second planar surface 460.

The rest of the second end 415 is recessed with respect to the co-planar surfaces of the protrusions 510 and the second planar surface 460, and the three co-planar surfaces provide a three-legged riding surface for the second end 415 of the rotary valve 135 against the first planar surface 270. That is why there is a gap between the second end 415 and the first planar surface 270 in the cross-section views in the drawings (see, for example, FIGS. 8 and 9, and the top of the rotary valve 135 in FIG. 7) except where the protrusions 510 or second planar surface 460 contact the first planar surface 270.

The resilient deflectable member 435 includes a relatively thin-walled cross piece 530 with a detent protrusion 535 with a smooth partially-spherical surface. The cross piece 530 extends over an exhaust path aperture 540 in the rotary valve 135.

Referring now to FIG. 6, the primary bore 420 of the rotary valve 135 fits with close tolerances around the exterior surface 225 of the inlet conduit portion 210 of the motor cylinder 125, with the second planar surface 460 against the first planar surface 270. The primary bore 420 covers the forward and reverse ports 240, 245. The rotary valve 135 is supported for rotation about the exterior surface 225 of the inlet conduit portion 210 between a forward position, a reverse position, and a forward power regulation (“FPR”) position in between the forward and reverse positions. The rotary valve 135 is illustrated in the forward position in FIG. 6.

When the rotary valve 135 is in the forward position (as illustrated), the valve passage 500 communicates between the forward port 240 and the forward supply passage 280, and the reverse biasing passage 450 communicates with the reverse port 245. With additional reference to FIG. 7, when the rotary valve 135 in the forward position and the throttle mechanism 155 is actuated, motive fluid flows from the inlet passage 230, through the forward port 240, through the valve passage 500, through the forward supply passage 280, and to the motor chamber 275 where it expands and causes the rotor 130 to rotate in a forward direction. At the same time, motive fluid flows from the inlet passage 230, through the reverse port 245, through the reverse biasing passage 450, and into a biasing chamber 600 (FIG. 9, explained in detail below).

When the rotary valve 135 is in the reverse position, the valve passage 500 communicates between the reverse port 245 and the reverse supply passage 285, and the forward biasing passage 445 communicates with the forward port 240. With the rotary valve 135 in the reverse position, motive fluid flows from the inlet passage 230, through the reverse port 245, through the valve passage 500, through the reverse supply passage 285, and to the motor chamber 275 where it expands and causes the rotor 130 to rotate in a reverse direction (opposite the forward direction). At the same time, motive fluid flows from the inlet passage 230, through the forward port 240, through the forward biasing passage 445, and into the biasing chamber 600.

With additional reference to FIG. 11, when the rotary valve 135 is in the FPR position, the valve passage 500 only partially aligns with the forward supply passage 280, and the FPR port 485 is also placed in communication with the forward supply port 280. Consequently, the flow of motive fluid into the motor chamber 275 is limited because some of the motive fluid flows out the FPR port into the exhaust passages (discussed in more detail below) without flowing into the motor chamber 275. In this regard, the FPR port may be termed a motor chamber bypass port as well, because it causes motive fluid to flow to exhaust without first flowing through the motor chamber 275. When the rotary valve 135 is in FPR position, the power of forward rotation of the rotor 130 is reduced, and torque applied by the tool 100 on a work piece is reduced. In the FPR position, the reverse biasing passages 450 still communicates between the reverse port 245 and the biasing chamber 600.

The outer housing 120, 115 includes an interior or inner surface 610 (i.e., facing the motor cylinder 125, valve 135, and bushing 175, see FIGS. 6 and 7) and an exterior or outer surface 615 (i.e., facing away from the motor cylinder 125, valve 135, and bushing 175, see FIGS. 2 and 7). As seen in FIG. 7, an exhaust passage 620 is defined between the inner surface 610 of the outer housing 115, 120 and the exterior surfaces 225, 265 of the motor cylinder 125 and bushing 175. A majority of the exhaust passage 620 extends substantially parallel to the main axis 195 to conduct exhausted motive fluid in a direction that is parallel to, but opposite the direction of motive fluid flowing into the tool 100, from the motor chamber 275 to the exhaust cap 190. A portion of the exhaust passage 620 extends through and is defined by the exhaust path aperture 540 in the rotary valve 135, and the exhaust passage 620 surrounds the rotary valve 135.

The inner surface 610 of the front housing 120 includes forward, reverse, and FPR detent grooves 625, 626, 627 into which the detent protrusion 535 of the deflectable member 435 of the rotary valve 135 is resiliently received when the rotary valve 135 is in the respective forward, reverse, and FPR positions. The detent protrusion 535 and detent grooves 625, 626, 627 together define a detent mechanism that resiliently holds the rotary valve 135 in the forward, reverse, and FPR positions (i.e., selected operating positions). In other embodiments, this arrangement may be reversed (e.g., with the deflectable member 435 on the front housing 120 and the detent grooves 625, 626, 627 on the rotary valve 135) or a different mechanism may be used.

While the illustrated embodiment provides only forward, reverse, and FPR detent grooves 625, 626, 627, other embodiments may include additional detent grooves to resiliently retain the rotary valve 135 in multiple FPR positions. Multiple FPR positions would permit the FPR port 485 to only partially register with the forward supply port 280, to restrict the amount of motive fluid that bypasses the motor chamber 275. One or more additional detent grooves may be provided to register a reverse power regulation (“RPR”) port 628 (see FIGS. 4B and 11) with the reverse supply port 285 to bypass the motor chamber 275 and limit the reverse output in the same way as the FPR port 485 does in forward operation.

As seen in FIGS. 7-9, the first and second valve seals 145, 150 create a seal between the respective first and second ends of the rotary valve 135 and the exterior surface 225 of the inlet conduit portion 210. The first valve seal 145 extends around the exterior surface 225 of the inlet conduit portion 210 and sits between the exterior surface 225 and the counter bore 425. The second valve seal 150 is received within the seal seat 255 of the inlet conduit portion 210.

With additional reference to FIG. 9, the pressure biasing chamber 600 is defined between the first valve seal 145, the counter bore 425, the pressure biasing surface 440, and the exterior surface 225 of the inlet conduit portion 210. The first valve seal 145 includes a first face facing toward and at least partially defining the biasing chamber 600, and a second face facing away from and not defining any portion of the biasing chamber 600. A depending portion 630 of the front housing 120 abuts the second face of the first valve seal 145, but the pressure biasing chamber 600 is not bounded at all by any portion of the outer housing 115, 120.

In the biasing chamber 600, the pressure of the motive fluid (whether supplied through the forward or reverse biasing passage 445, 450) forces the second face of the first seal 145 against the depending portion 630 of the front housing 120, but the pressure does not apply a direct force against the front housing 120 (only indirectly through the first seal 145). The pressure is also applied to the pressure biasing surface 440 to give rise to a biasing force that urges the rotary valve 135 forward (i.e., to the left in FIGS. 7-9) to hold the second planar surface 460 (at the second end 415 of the rotary valve 135) tightly against the first planar surface 270.

A face seal arises between the first and second planar surfaces 270, 460 to resist the loss or leakage of motive fluid between the first and second planar surfaces 270, 460. Because the second planar surface 460 does not extend around the entire circumference of the second end 415 of the rotary valve 135, the biasing force is concentrated on the rotary valve second planar surface 460 and the two stabilizing protrusions 510. This provides a smaller surface area for transferring the biasing force to the first planar surface 270 than if the second planar surface extended around the entire circumference of the second end 415 of the rotary valve 135, and consequently a higher pressure applied by the second planar surface 460 against the first planar surface 270 and a better seal. The face seal is also advantageous because it does not include sealing members that will wear down during repeated actuation of the rotary valve 135; instead the smooth planar surfaces 270, 460 slide with respect to each other without significant wear. Thus, substantially all motive fluid flowing through the valve passage 500 and into the forward and reverse supply passages 280, 285 reaches the motor chamber 275 (unless the rotary valve 135 is in the FPR position in which some of the motive fluid is vented to exhaust intentionally). Leakage from the interface between the valve passage 500 and forward and reverse supply passages 280, 285 due to motive fluid flowing between the first and second planar surfaces 270, 460 is minimized or completely eliminated.

With reference to FIGS. 2 and 6, a ring seat 655 is formed in the outer surface 615 of the front housing 120. The ring 160 is supported in the ring seat 655 for rotation about the front housing 120. The ring 160 rotates about an axis of rotation that is collinear with the main axis 195.

A slot 660 (FIGS. 2 and 6) is formed in the ring seat 655. The valve actuator 140 includes an actuator head 670 and a stem 675. The stem 675 extends through the slot 660 in the ring seat 655 and includes a deflectable slot 680 that is sized to snap-fit around the enlarged head 480 of the mounting finger 475 of the rotary valve 135 to releasably interconnect the valve actuator 140 to and valve 135. In other embodiments, the finger and expandable slot 475, 680 may be reversed such that the stem 675 includes the enlarged head 480 and the rotary valve 135 includes the expandable slot 680. The present invention provides an interface that is simple to assemble or disassemble by hand, with no need for any tools. Currently-known and practiced constructions for reversing switches require a screwdriver, Allen wrench, or like tool to assemble the valve actuator. While the illustrated snap-fit configuration is one embodiment of the present invention, other constructions and embodiments may include other means for interconnecting the rotary valve with a valve actuator by hand and without the use of tools.

The ring 160 includes a recess 685 ribs or other abutment surfaces that engage the opposite sides of the actuator head 670, and the ring 160 covers the valve actuator 140. The user interface to control forward, reverse, and FPR operation of the tool 100 is therefore the ring 160. Because the ring 160 covers the actuator head, it eliminates any visible or exposed connection interface (e.g., a screw) which can be unsightly or become loosened during tool use. Enclosing the actuator head 670 within the ring 670 also reduces the likelihood of accidental disengagement of the valve actuator 140 from the rotary valve 135.

An operator toggles the tool 100 between the forward, reverse, and FPR operations by rotating the ring 160 in one direction or the other, which overcomes the detent force of the detent mechanism (detent protrusion 535 and detent grooves 625, 626, 627) and causes the actuator head 670 to slide along the outer surface 615 of the front housing 120. This in turn causes movement of the rotary valve 135 through the stem 675. Rotating the ring 160 thereby switches direction of operation of the tool 100. The operator is rewarded with a tactile feedback as the detent mechanism (detent protrusion 535 and detent grooves 625, 626, 627) clicks into the forward, reverse, and FPR positions.

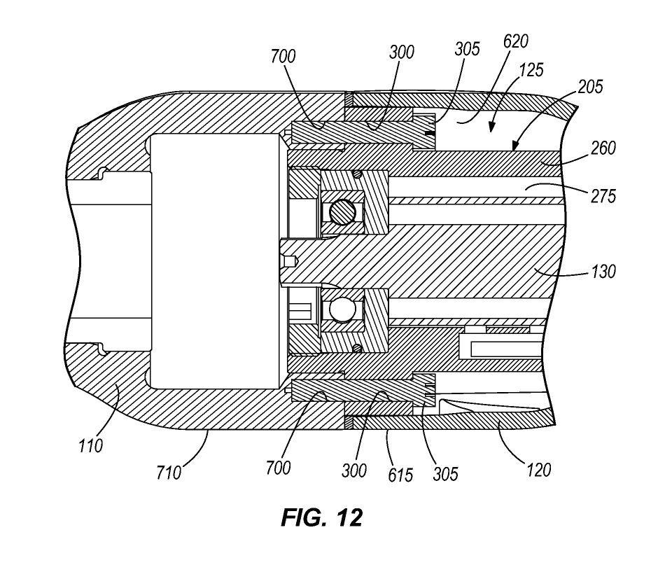

FIGS. 7 and 12 illustrate the mounting arrangement for the work attachment. The work attachment includes a plurality of attachment mounting holes 700 that align with the cylinder mounting holes 300. In the illustrated construction, the work attachment 110 is secured to the motor cylinder 125 with the fasteners 305. More specifically, the fasteners 305 extend through the cylinder mounting holes 300 and attachment mounting holes 700. In the illustrated embodiment, the attachment mounting holes 700 are internally threaded to receive an externally threaded end of the fasteners 305, and the cylinder mounting holes 300 are sized smaller than an enlarged head of the fasteners 305 so that the enlarged head bears against the flange portion of the motor cylinder 125. When mounted to the motor cylinder 125, the work attachment 110 is interconnected to the motor rotor 130 and is operable to perform work in response to rotation of the motor rotor 130.

The front housing 120 includes pockets in its interior surface 610 into which the housing support projections 213 of the motor cylinder 125 fit snugly. The interconnection of the pockets and housing support projections 213 properly locates (axially and radially) the front housing 120 with respect to the motor cylinder 125, and resists torsional loads between the front housing 120 and motor cylinder 125. A compliant gasket 710 sits between and provides a pressure tight seal between the work attachment 110 and the front housing 120 to resist leaking of exhaust motive fluid.

With the housing support projections 213 bottomed out in the pockets of the front housing 120, the front end of the outer housing extends around the flange portion of the motor cylinder 125 with a close clearance fit. The first ring seal 165, valve actuator 140, ring 160, and second ring seal 170 are then installed on the ring seat 655 portion of the front housing 120. Next the rear housing 115, exhaust cap 190, and inlet bushing 175 are assembled, with the first inlet seal 180 around the inlet bushing 175 above the threaded portion 310, and with the second inlet seal 185 and inlet washer 187 sandwiched between a portion of the inlet bushing 175 and a portion of the exhaust cap 190. The threaded end 310 of the inlet bushing 175 is threaded into the threaded portion of the inlet passage 230.

As the inlet bushing 175 is threaded into the inlet passage 230, it applies an axial thrust load on the rear housing 115 through the inlet washer 187, second inlet seal 185, and exhaust cap 190. As it is squeezed between the inlet bushing 175 and exhaust cap 190, the second inlet seal 185 provides a pressure-tight seal therebetween, and acts as a compliant member to accommodate tolerance stackups of the rigid components in the assembly. The rear housing 115 in turn applies a thrust load on the front housing 120 through a step in the rear housing 115 and the rear end of the front housing 120 (including the depending portion 630.

With work attachment 110 mounted to the motor cylinder 125 and the front housing mounted around the motor cylinder 125, the fasteners 305 are hidden from view outside of the tool 100 because they are within the work attachment 110 and the cavity bounded by the interior surface 610 of the outer housing 115, 120. Additionally, the outer surface of the work attachment 110 and the outer surface 615 of the outer housing 115, 120 are substantially aligned when the tool 100 is assembled, to create a substantially continuous tool outer surface that includes the outer surfaces of both the work attachment 110 and the outer housing 115, 120. Hiding the fasteners 305 in this manner provides a sleek appearance to the tool 100, resists tampering and disassembly of the tool, and physically shields the fasteners 305 from being caught on wires, edges, and other structures in a confined space, construction environment, or other work environment.

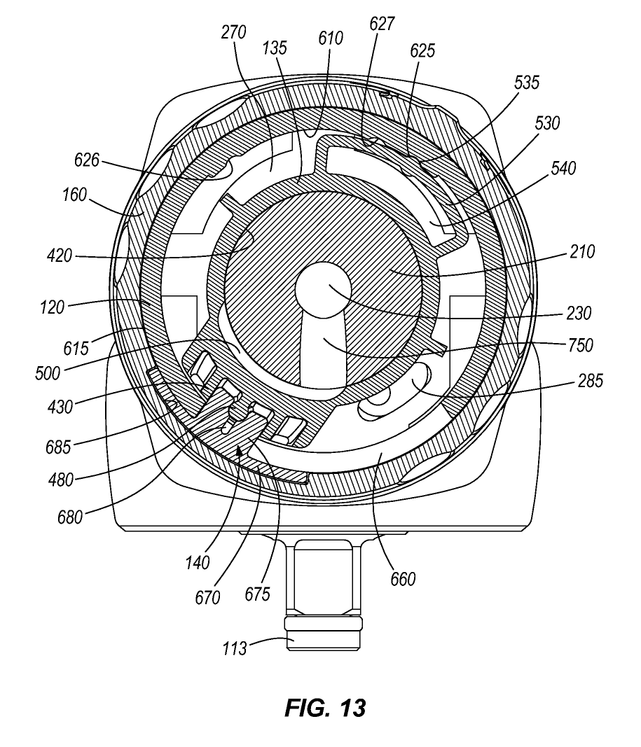

FIGS. 13-15 include alternative embodiments of the interface between the inlet passage 230 and the rotary valve 135, in which a single supply port 750 communicates between the inlet passage 230 and the exterior surface 225 of the inlet conduit portion 210. In FIG. 13, the valve passage 500 is made large enough to stretch from the single supply port 750 to the forward supply passage 280 (i.e., with the right end of the valve passage 500 communicating with the single supply port 750 and the left end of the valve passage 500 communicating with the forward supply passage 280 as viewed in FIG. 13) when the rotary valve 135 is in the forward position, and to stretch from the single supply port 750 (i.e., at the left end of the valve passage 500 as viewed in FIG. 13) to the reverse supply passage 285 (i.e., at the right end of the valve passage 500) when the rotary valve 135 is in the reverse position.

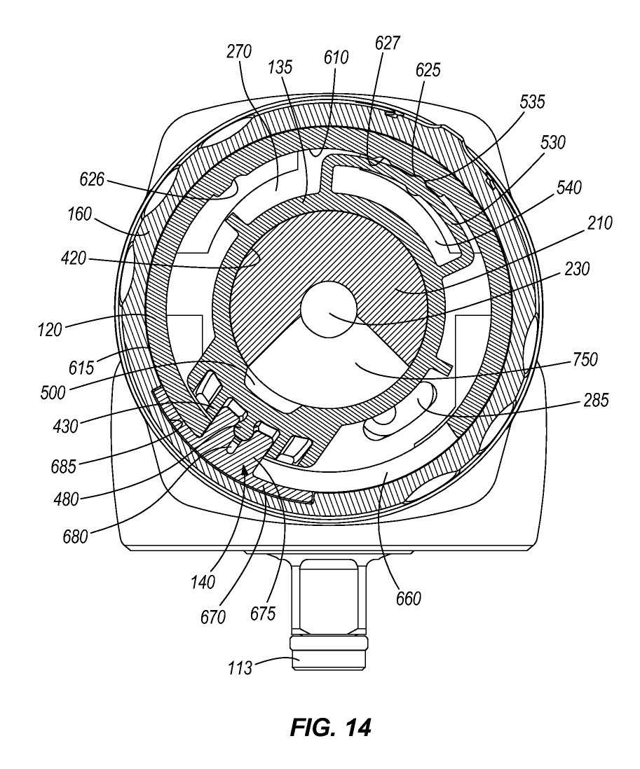

In FIG. 14, the single supply port 750 widens at the exterior surface 225, so that the single supply port 750 stretches from the valve passage 500 in the forward position (i.e., with the valve passage 500 communicating between the forward supply passage 280 and the left end of the single supply port 750 as viewed in FIG. 14) to the valve passage 500 in the reverse position (i.e., with the valve passage 500 communicating between the reverse supply passage 285 and the right end of the single supply port 750).

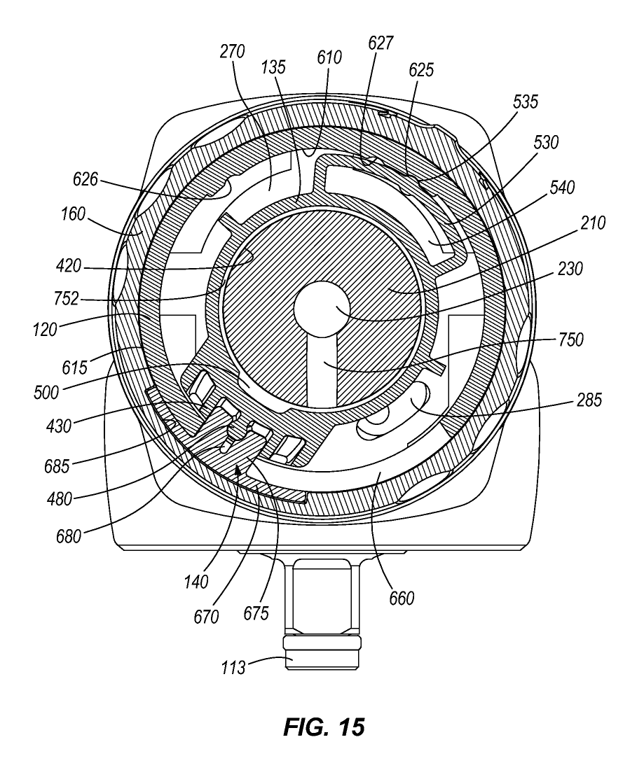

In FIG. 15, the rotary valve 135 includes an annular groove in the primary bore 420 that communicates with the valve passage 500. The single supply port 750 communicates with the annular groove 752 in the primary bore 420. The valve passage 500 communicates between the annular groove 752 and the forward supply passage 280 in the forward position (as viewed in FIG. 15) and between the annular groove 752 and the reverse supply passage 285 in the reverse position.

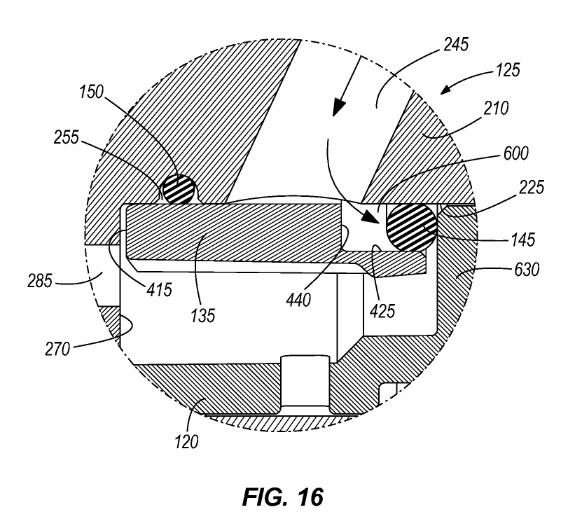

FIG. 16 includes an alternate embodiment of the interface between the inlet valve 135 and the inlet conduit portion 210 forming the pressure biasing chamber 600. Rather than undercuts 445, 450 in the primary bore 420 to communicate with the pressure biasing chamber 600, the counterbore 425 extends inwardly to form a gap between the pressure biasing surface 440 and the end of the inlet conduit portion 210. This gap communicates the forward and reverse supply ports 240, 245 with the pressure biasing chamber 600.

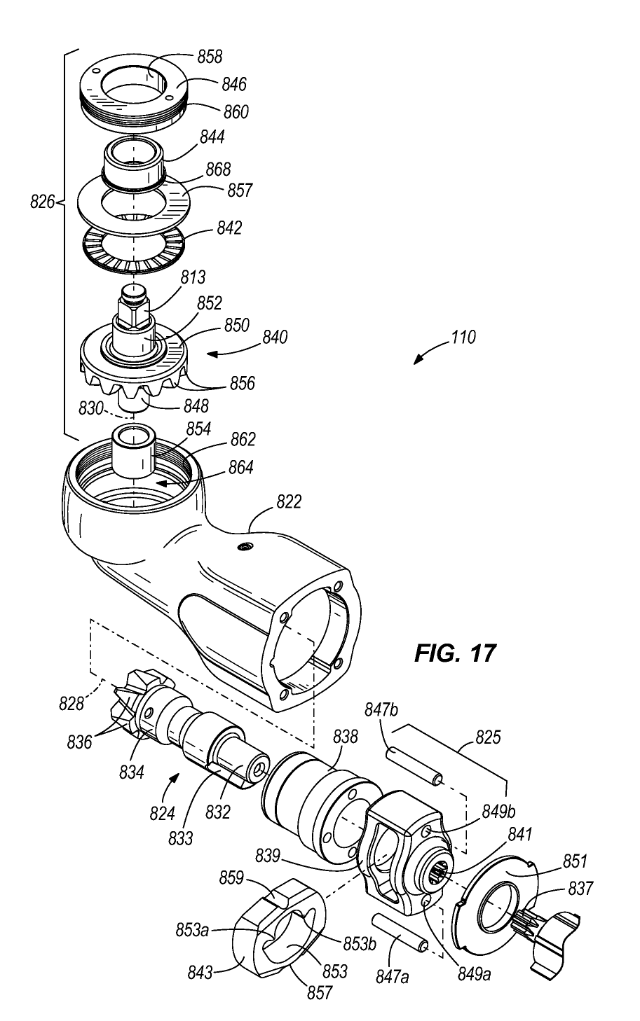

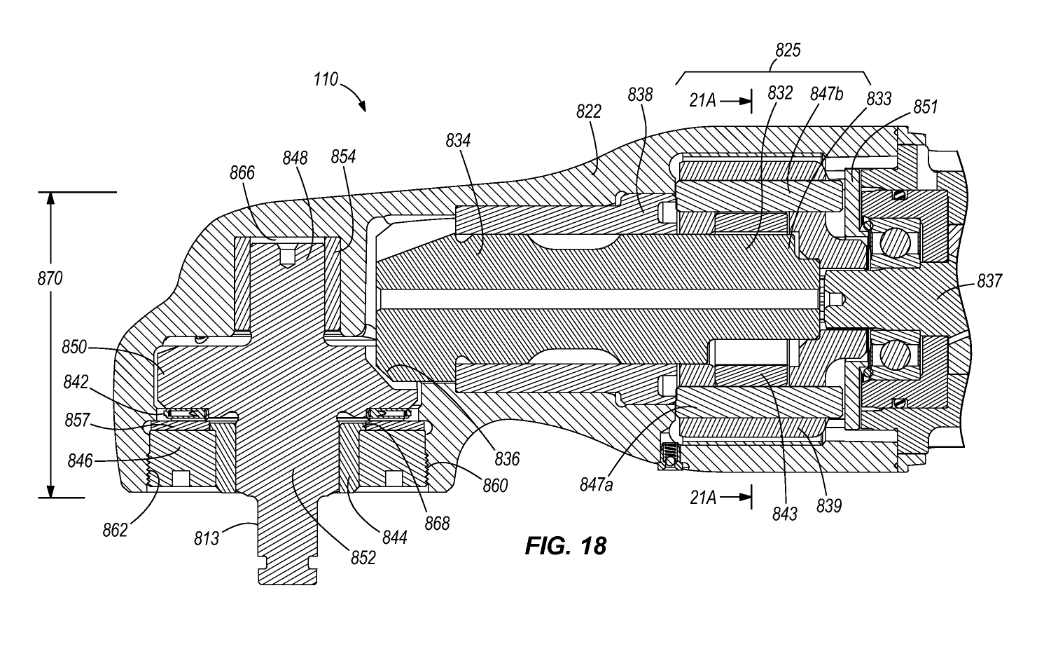

FIGS. 17 and 18 illustrate the angle head work attachment 110, which includes an angle housing 822, a pinion shaft 824, an impact mechanism 825 and a gear assembly 826. The angle housing 822 defines first and second non-parallel axes 828, 830. In some embodiments, the first axis 828 is perpendicular to the second axis 830. In other embodiments (not shown), the first axis 828 is at an acute or obtuse non-parallel angle to the second axis 830.

The pinion shaft 824 has a first end 832 and a second end 834. The first end 832 includes an impact jaw 833, and the second end 834 includes pinion teeth 836. A bushing or bearing 838 supports the pinion shaft 824 for rotation about the first axis 828 within the angle housing 822.

The impact mechanism 825 includes a hammer frame 839 having a splined aperture 841 sized to receive the splined end of the rotor 837, such that the hammer frame 839 is rotated by the rotor 837. The impact mechanism 825 further includes a hammer 843 coupled to the hammer frame 839 via two pins 847a, 847b. The pins 847a, 847b extend through respective apertures 849a, 849b in the hammer frame 839 and are retained in the respective apertures 849a, 849b by a washer 851, the angle housing 822 and the bearing 838. The hammer 843 is coupled for rotation with the hammer frame 839 by the pins 847a, 847b.

The hammer 843 defines an aperture 853 for receiving the first end 832 of the pinion shaft 824. The hammer 843 includes a first impact surface 853a and a second impact surface 853b. The first impact surface 853a strikes impact jaw 833 to rotate the pinion shaft 824. The first impact surface 853a is oriented to rotate the pinion shaft 824 in a first direction and the second impact surface 853b is oriented to rotate the pinion shaft 824 in a second direction, opposite the first direction.

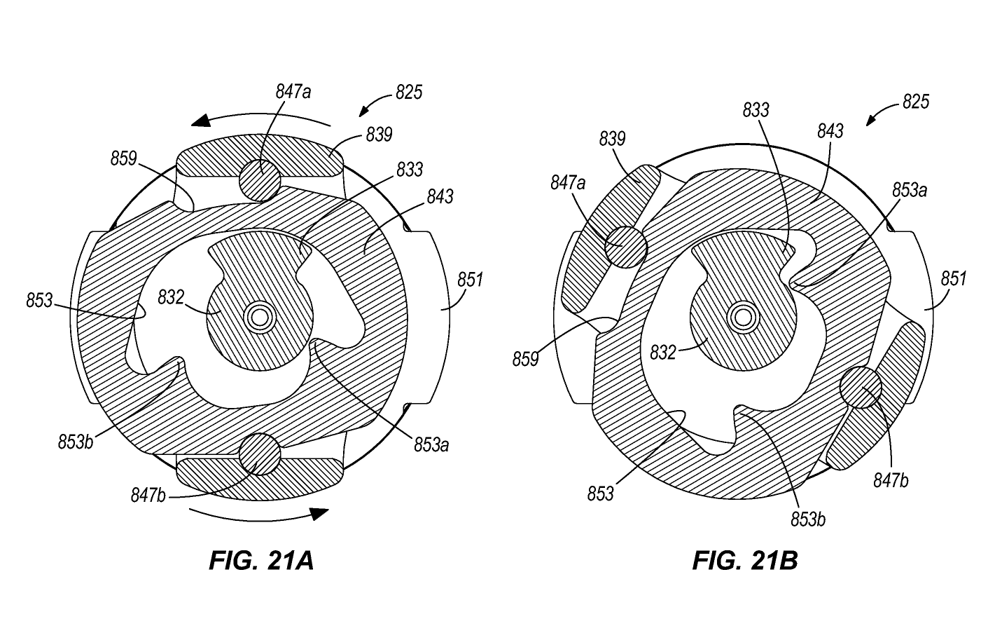

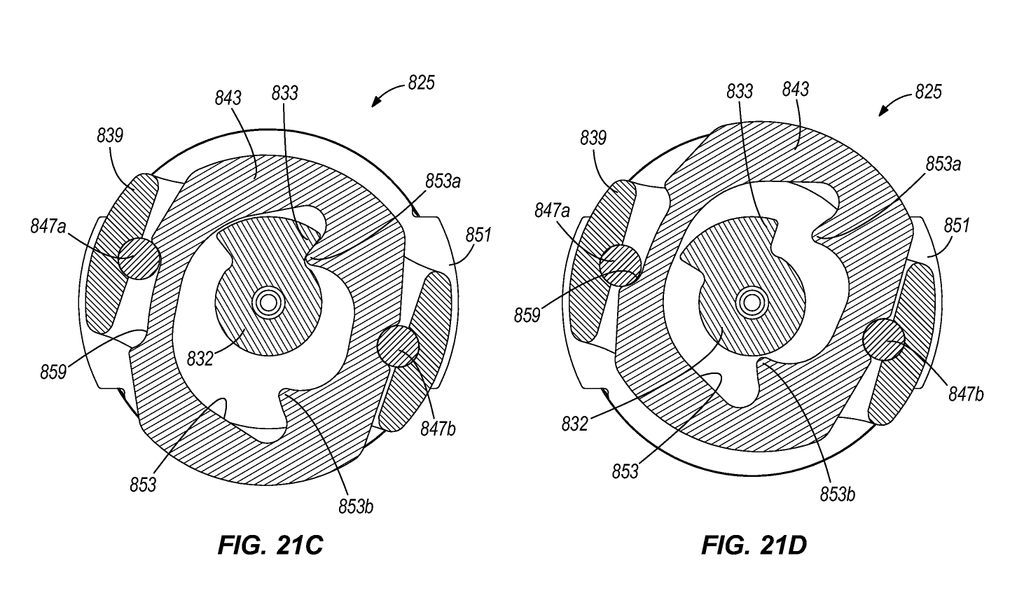

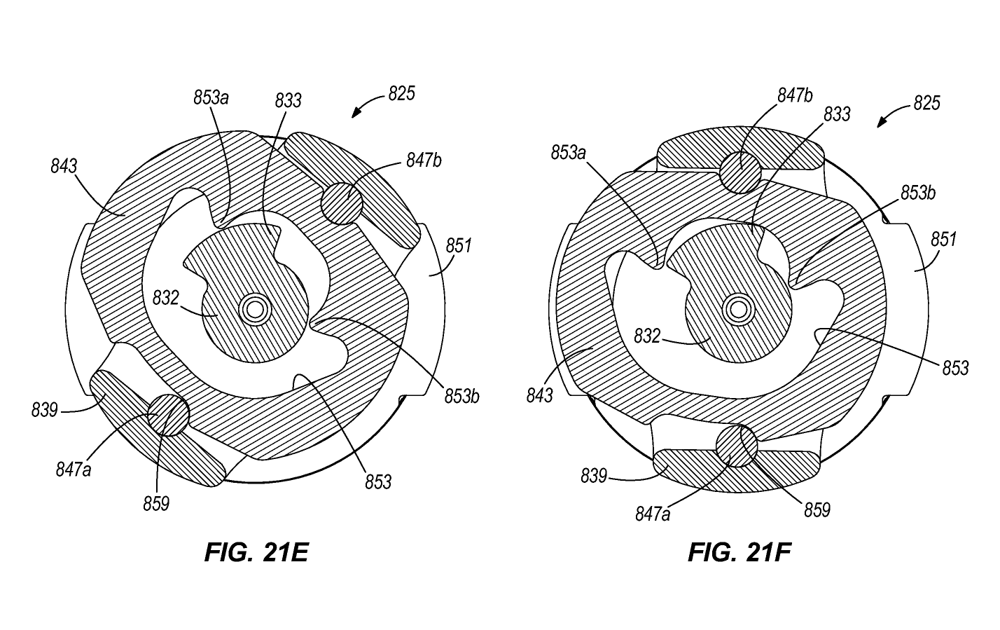

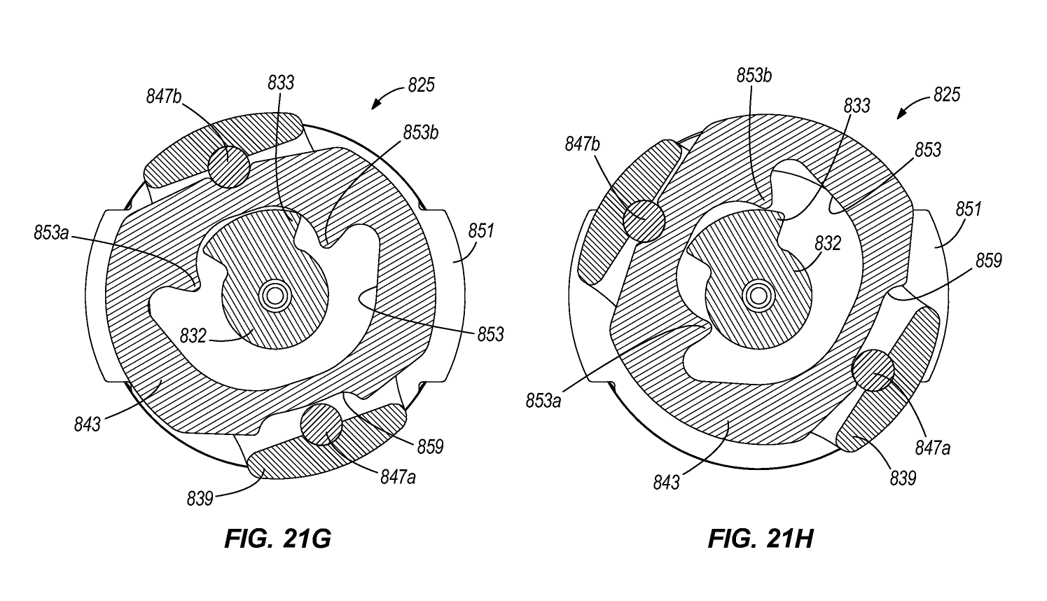

The hammer 843 further defines an elongate groove 857 for receiving the pin 847a and a groove 859 for receiving the pin 847b. The elongate groove 857 permits the hammer 843 to rotate about a range of angles within the hammer frame 839. The groove 859 defines an axis about which the hammer 843 is rotatable with respect to the hammer frame 839. FIGS. 21A-21I illustrate an impact cycle of the angle head 110 of the pneumatic impact tool 100 of FIGS. 17-20. The impact cycle is repeated once every rotation and is illustrated in FIGS. 21A-21I in the forward direction in which the first impact surface 853a impacts the first side of the jaw 833. When operated in the reverse direction, the second impact surface 853b impacts the other side of the jaw 833. In the illustrated embodiment the projection 833 acts as the anvil in relation to the hammer 843. The projection 833 (or anvil) is impacted by the first or second impact surface 853a, 853b of the hammer 843.

Returning to FIGS. 17 and 18, the gear assembly 826 includes a bevel gear 840, a thrust bearing 842, an axial bearing 844 and a retaining nut 846. The bevel gear 840 includes an upper shaft 848, a splined portion 850, and an output spindle 852. The upper shaft 848 is supported for rotation about the second axis 830 with a bushing 854. The splined portion 850 is located in between the upper shaft 848 and the output spindle 852 and includes bevel teeth 856. The bevel teeth 856 are sized and shaped to meshingly engage with the pinion teeth 836 of the pinion shaft 824. The output spindle 852 can have a standard square drive, such as square drive 813, or other suitable output drive.

The thrust bearing 842 is trapped between the retaining nut 846 and the splined portion 850 of the bevel gear 840. In some embodiments (not shown), the thrust bearing 842 is integrally formed with the retaining nut 846. The thrust bearing 842 helps to support the bevel gear 840 for rotation about the second axis 830 and resists movement of the bevel gear 840 in a direction parallel to the second axis 830. In some embodiments, the thrust bearing 842 is a needle bearing. The gear assembly 826 can include a flat washer 851 between the retaining nut 846 and the thrust bearing 842.

The axial bearing 844 surrounds the output spindle 852 and is sandwiched between the retaining nut 846 and the output spindle 852. In some embodiments, the axial bearing 844 is press fit to the inside surface 858 of the retaining nut 846. The axial bearing 844 is separate from the thrust bearing 842 and resists movement of the bevel gear 840 in a direction perpendicular to the second axis 830. In some embodiments (not shown), the axial bearing 844 is integrally formed with the retaining nut 846.

The retaining nut 846 has an inner surface 858 and an outer surface 860. The outer surface 860 is threaded for engagement with an inner surface 862 of the angle housing 822 to secure the retaining nut 846 to the angle housing 822. The inner surface 858 surrounds the axial bearing 844 and the output spindle 852.

The gear assembly 826 can be assembled with the angle housing 822 by sequentially dropping the components of the gear assembly 826 through an opening 864 in the angle housing 822. First, the bushing 854 is dropped into a recess 866 in the angle housing 822 (see FIG. 18). Next, the bevel gear 840 is dropped into the angle housing 822 so that the upper shaft 848 is surrounded by the bushing 854. Then, the thrust bearing 842 is fit over the output spindle 852 and is dropped through the opening 864 to bear against the splined portion 850. Next, the axial bearing 844 is fit over the output spindle 852 and dropped through the opening 864. Then, the retaining nut 846 is fit over the output spindle 852 and is dropped through the opening 864 and is rotated so that the outer surface 860 threadingly engages the inner surface 862 of the angle housing 822. The retaining nut 846 acts against a shoulder 868 of the axial bearing 844. The retaining nut 846 can be tightened onto the angle housing 822 to secure the gear assembly 826 within the angle housing 822. In some embodiments, the axial bearing 844 is press-fit within the retaining nut 846 so that the retaining nut 846 and the axial bearing 844 are dropped into the opening 864 together.

The angle head 110 transmits rotation of the pinion shaft 824 about the first axis 828 to rotation of the output spindle 852 about the second axis 830. To do this, the pinion teeth 836 of the pinion shaft 824 meshingly engage the bevel teeth 856 of the bevel gear 840. As the pinion shaft 824 rotates about the first axis 828 in response to the impact mechanism 825, the pinion teeth 836 impact the output spindle 852 to functionally drive the output spindle 852 via the engagement of teeth 836 and 856. The thrust bearing 842 and the axial bearing 844 support the bevel gear 840 for rotation. The thrust bearing 842 resists movement of the bevel gear 840 in a direction parallel to the second axis 830, while the axial bearing 844 resists movement of the bevel gear 840 in a direction perpendicular to the second axis 830.

The term “functionally drive” is herein defined as a relationship in which the pinion teeth 836 rotate to impact the bevel teeth 856 and thereby cause intermittent rotation of the output spindle 852, in response to the impact of pinion teeth 836 on the bevel teeth 856. The pinion teeth 836 intermittently impact the bevel teeth 856, and therefore the pinion teeth 836 functionally drive rotation of the output spindle 852. Further, any element that directly or indirectly drives rotation of the hammer to impact the anvil may be said to “functionally drive” any element that is rotated by the anvil as a result of such impact.

The angle head work attachment 110 of the pneumatic tool 100 can be useful in order to position the output spindle 852 of the tool 100 in an orientation that is convenient for the task that is being performed while permitting the operator to grasp and manipulate the pneumatic tool 100 with the hand grip 108 in an orientation that is convenient for the operator. A head height dimension 870 of the angle head 110 is illustrated in FIG. 18. The head height dimension 870 is the axial distance from the top of the angle head 110 to the beginning edge of the square drive feature 813 of the output spindle 852. The head height dimension 870 is reduced so that the angle head 110 can fit into small spaces.

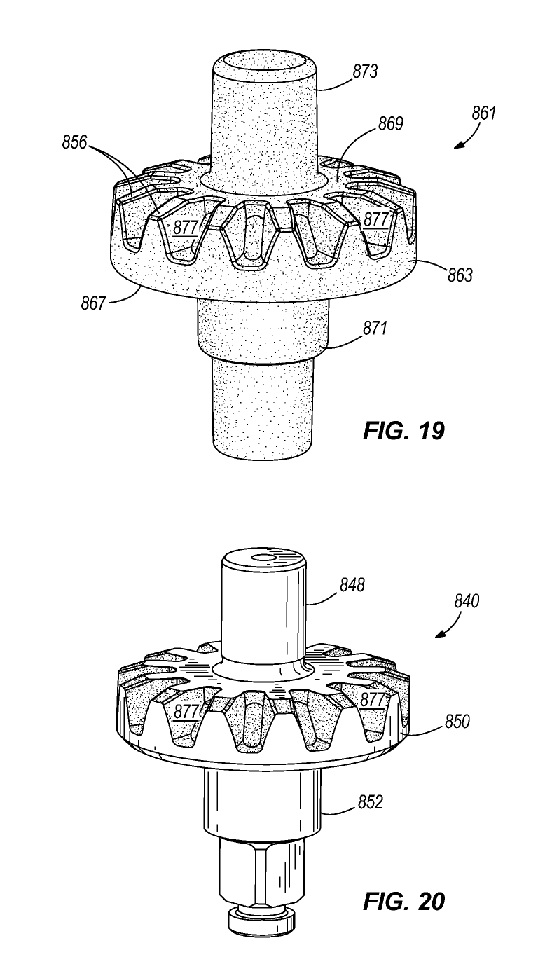

Referring now to FIGS. 19 and 20, the upper shaft 848, splined portion 850 and output spindle 852 of the bevel gear 840 can be integrally formed with one another such that the bevel gear 840 is a single, monolithic piece. The bevel gear 840 can be formed through a two-step process. In the first step, a bevel gear blank 861 is formed from raw material through a forging process, as illustrated in FIG. 19. The blank 861 includes a splined portion 863 having first and second sides 867, 869, a first extension 871 extending from the first side 867 of the splined portion 863, and a second extension 873 extending from the second side 869 of the splined portion 863. The blank 861 can be formed by precision forging to form precision forged surfaces 877 of bevel teeth 856 of the splined portion 863 within strict tolerances.

In the second step, the blank 861 of FIG. 19 is machined to transform the blank 861 into the bevel gear 840 as illustrated in FIGS. 17, 18 and 20. Machining can include cutting, polishing and/or grinding processes as are known in the art to remove material from selected portions of the blank 861. The machined portions are indicated in FIG. 20 by the solid surfaces. Various surfaces of the splined portion 863 are machined to form the splined portion 850, and the first and second extensions 871, 873 are machined to form the output spindle 852 and upper shaft 848, respectively. The forged surfaces 877 of the bevel teeth 856 are not subject to machining, as indicated by the unchanged mottling in FIGS. 19 and 20.

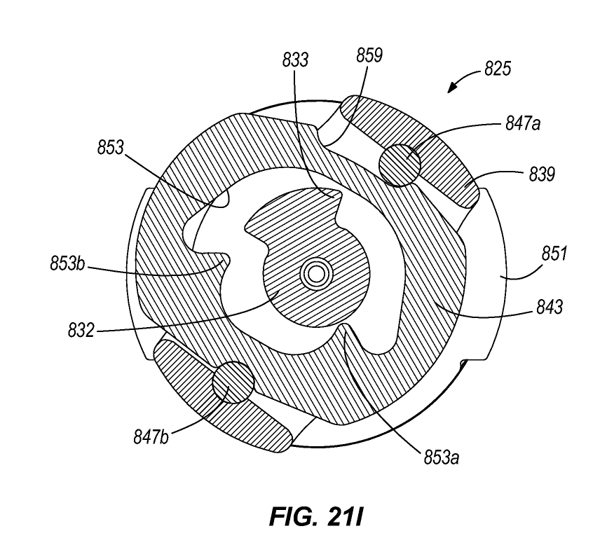

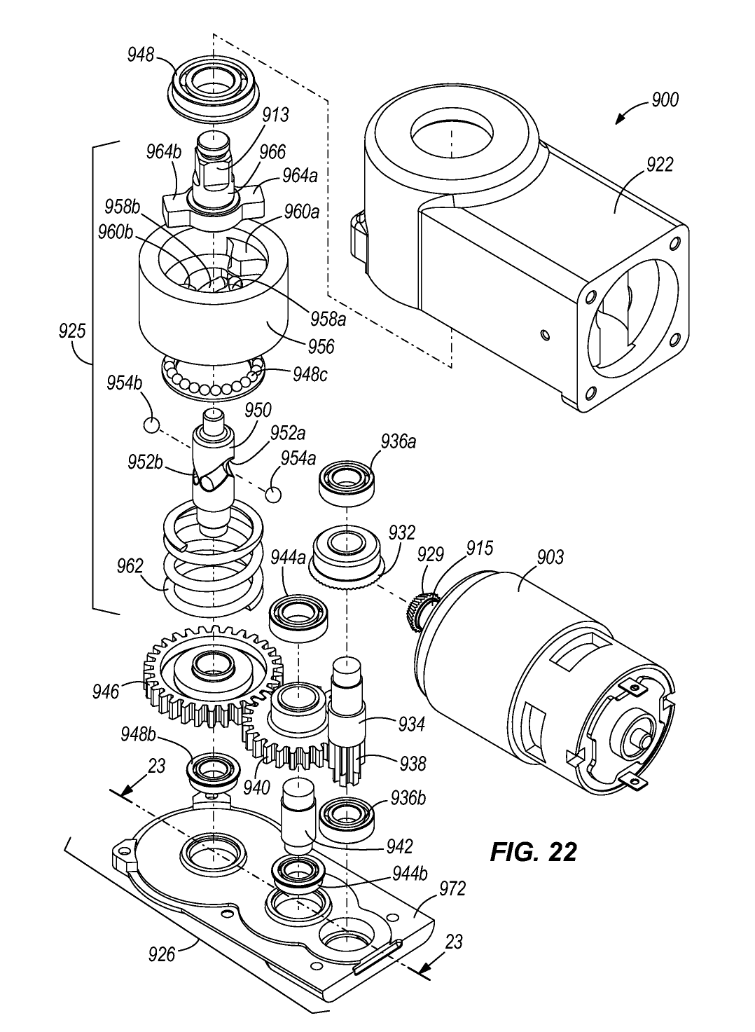

Another embodiment of an angle head work attachment 900 for an impact tool is illustrated in FIGS. 22 through 24J. The angle head work attachment 900 is coupled to a handle and motor 903 having a rotor 915. The illustrated motor 903 is an electric motor, but any suitable prime mover, such as the pneumatic motor shown in FIGS. 1-16, can be utilized. The angle head work attachment 900 includes an angle housing 922 that supports an impact mechanism 925 and a gear assembly 926. The rotor 915 rotates about a first axis 928. The rotor 915 includes at least one tooth, and in the illustrated embodiment includes a first bevel gear 929 coupled thereto. The first bevel gear 929 actuates the gear assembly 926 and the impact mechanism 925 to functionally drive an output, such as a square drive 913, as shown in the illustrated embodiment. The square drive 913 is rotated about a second axis 930 which is non-parallel to the first axis 928. In the illustrated embodiment, the second axis 930 is perpendicular to the first axis 928.

The illustrated gear assembly 926 includes a second bevel gear 932 that meshingly engages the first bevel gear 929. The second bevel gear 932 is coupled to a shaft 934 for rotation with the shaft 934. The shaft 934 is supported in the angle head 900 by bearings 936a, 936b. The shaft 934 includes a splined portion 938 near bearing 936b. The shaft 934 rotates about an axis 939. The splined portion 938 engages a gear, such as a first spur gear 940, such that rotation of the splined portion 938 causes rotation of the first spur gear 940 about an axis 943. The first spur gear 940 is coupled to a second shaft 942 for rotation with the second shaft 942 about the axis 943. The second shaft 942 is supported for rotation with respect to the angle head 900 by bearings 944a, 944b. The axes 930, 939 and 943 are all substantially parallel to each other and are thus each substantially perpendicular to axis 928. The first spur gear 940 is coupled to a second spur gear 946 to cause rotation of the second spur gear 946 about the axis 930. The second spur gear 946 is coupled to the square drive 913 through the impact mechanism 925 for selectively rotating the square drive 913. The second spur gear 946 and the square drive 913 are supported for rotation with respect to the angle head 900 by bearings 948a, 948b, 948c.

The impact mechanism 925 can be a standard impact mechanism, such as a Potts mechanism or a Maurer mechanism. The illustrated impact mechanism 925 includes a cam shaft 950 coupled to the second spur gear 946 for rotation with the second spur gear 946 about the second axis 930. The illustrated cam shaft 950 includes opposite cam grooves 952a, 952b that define pathways for respective balls 954a, 954b. The illustrated impact mechanism 925 further includes a hammer 956 that includes opposite cam grooves 958a, 958b that are substantially minor-images of cam grooves 952a, 952b. The balls 954a, 954b are retained between the respective cam grooves 952a, 952b, 958a, 958b. The hammer 956 also includes first and second opposite jaws 960a, 960b.

A biasing member, such as an axial compression spring 962 is positioned between the second spur gear 946 and the hammer 956 to bias the hammer 956 away from the second spur gear 946. In the illustrated embodiment, the spring 962 rotates with the second spur gear 946 and the bearing 948c permits the hammer 956 to rotate with respect to the spring 962. Other configurations are possible, and the illustrated configuration is given by way of example only.

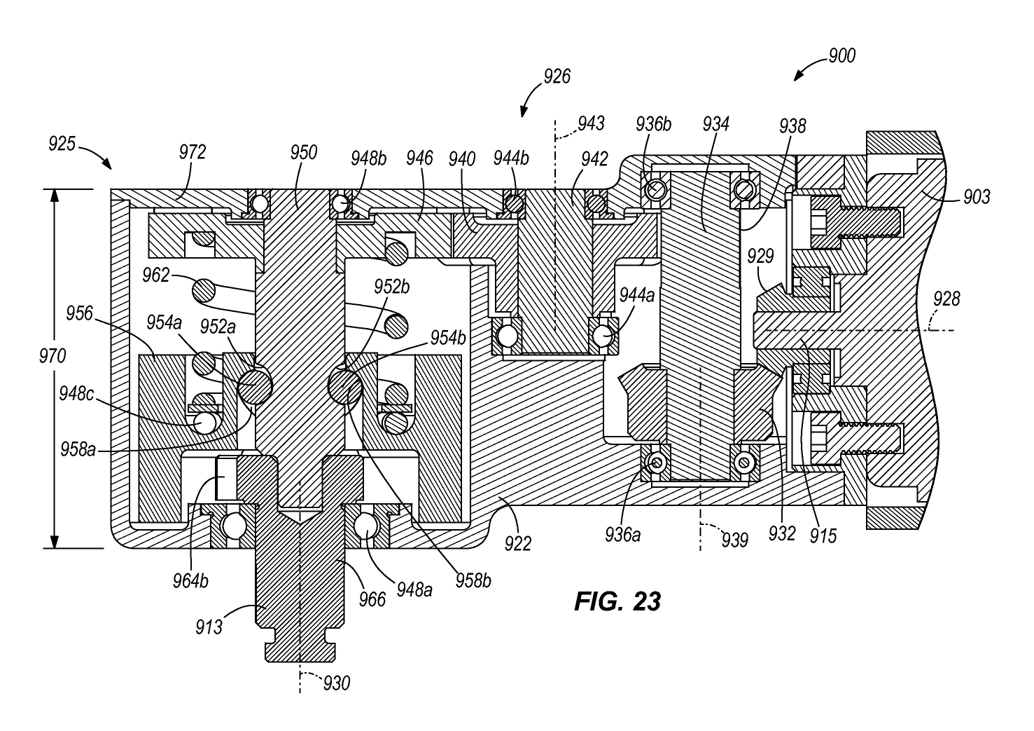

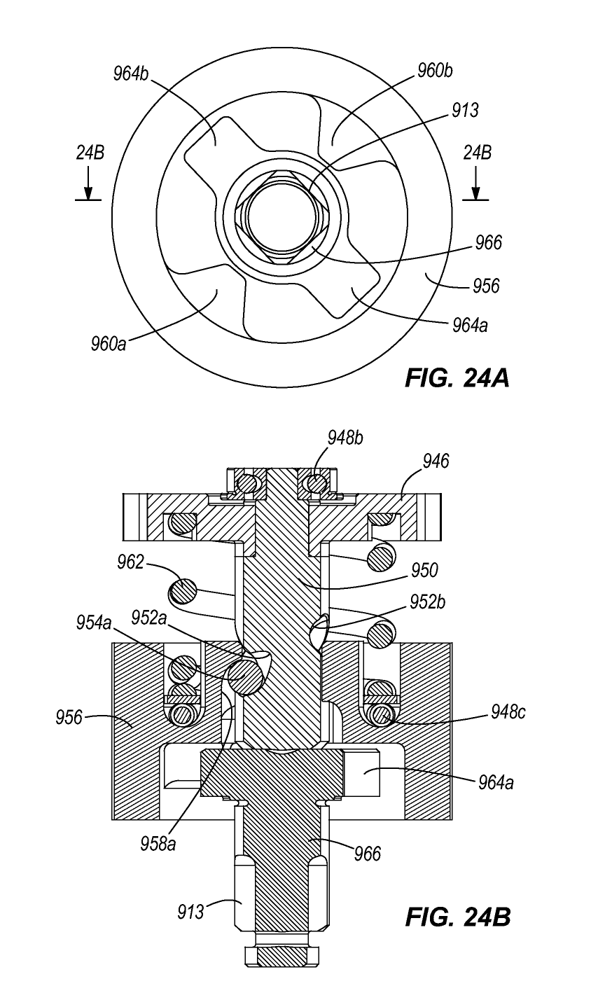

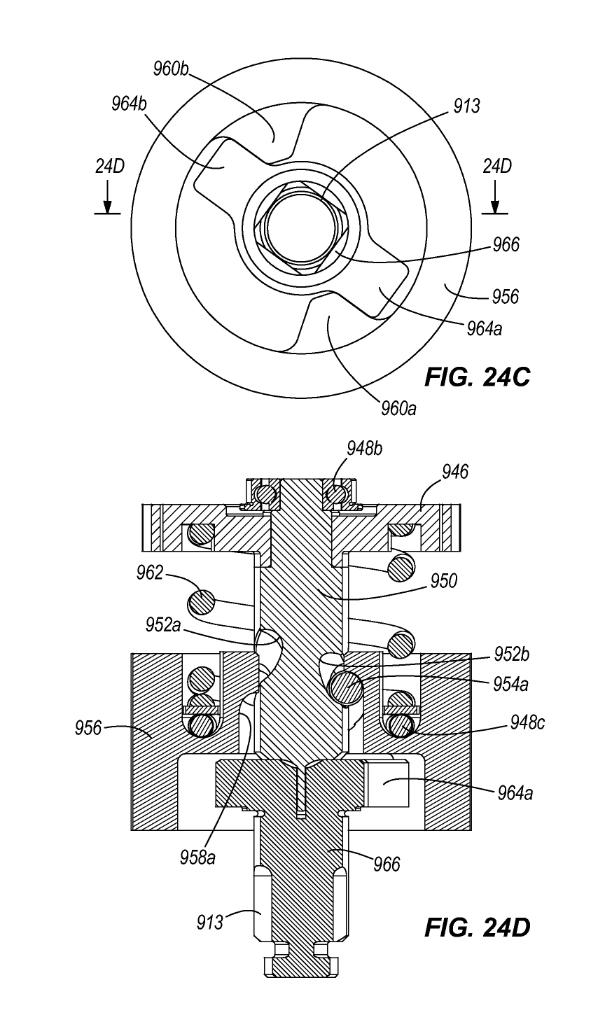

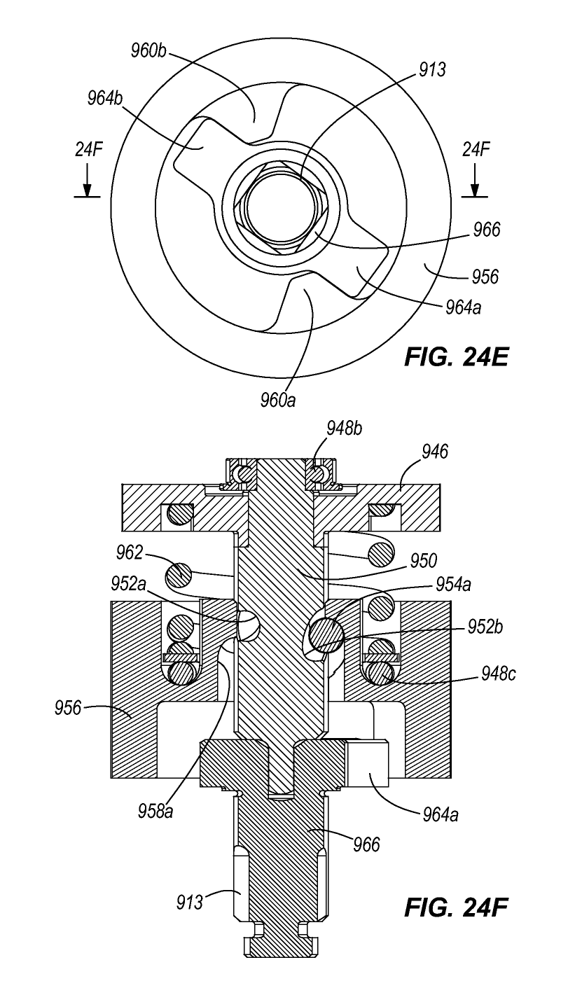

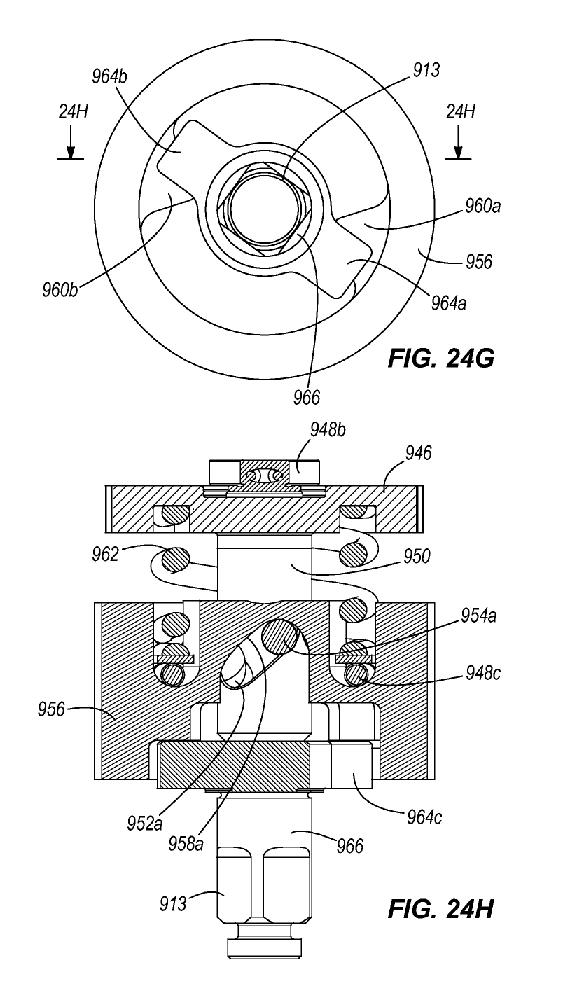

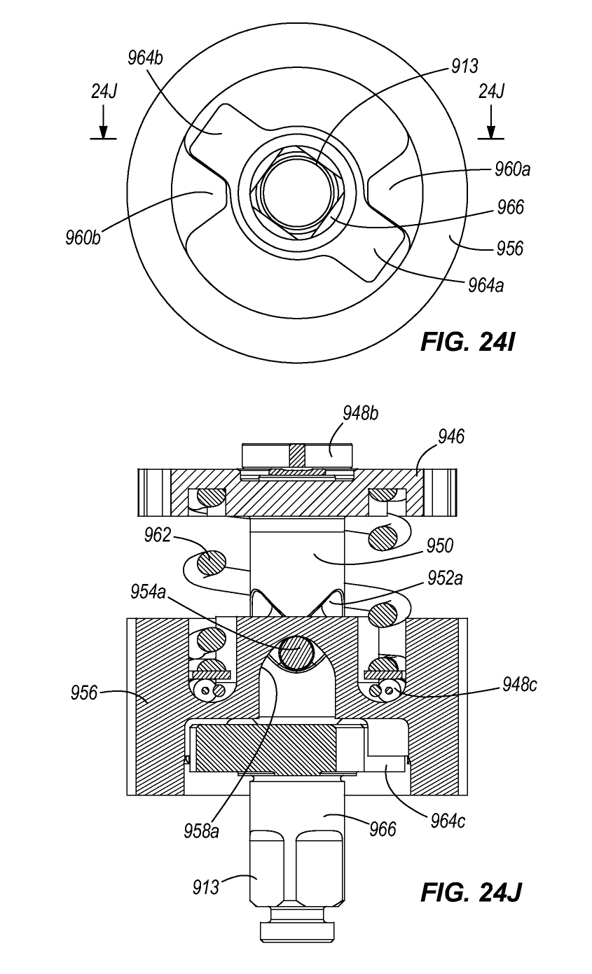

The illustrated square drive 913 is formed as a single unitary, monolithic piece with first and second jaws 964a, 964b to create an anvil 966. The anvil 966 is supported for rotation within the angle head 900 by the bearing 948a. The jaws 960a, 960b impact respective jaws 964a, 964b to functionally drive the square drive 913 in response to rotation of the second spur gear 946. The impact cycle is repeated twice every rotation and is illustrated in FIGS. 24A-24J in which the jaws 960a, 960b impact the jaws 964a, 964b. The spring 962 permits the hammer 956 to rebound after impact and balls 954a, 954b guide the hammer 956 to ride up around the cam shaft 950, such that jaws 960a, 960b are spaced axially from jaws 964a, 964b. The jaws 960a, 960b are permitted to rotate past the jaws 964a, 964b after the rebound. FIGS. 24A-24J illustrate an impact cycle of the impact tool of FIGS. 22 and 23. Two such impact cycles occur per rotation of the hammer 956.

A head height dimension 970 of the angle head 900 is illustrated in FIG. 23. The head height dimension 970 is the axial distance from the top of the angle head 900 to the beginning edge of the square drive feature 913 of the anvil 966. The head height dimension 970 is reduced so that the angle head 900 can fit into small spaces. A plate 972 defines a top of the angle head 900 and is substantially planar in the illustrated embodiment.

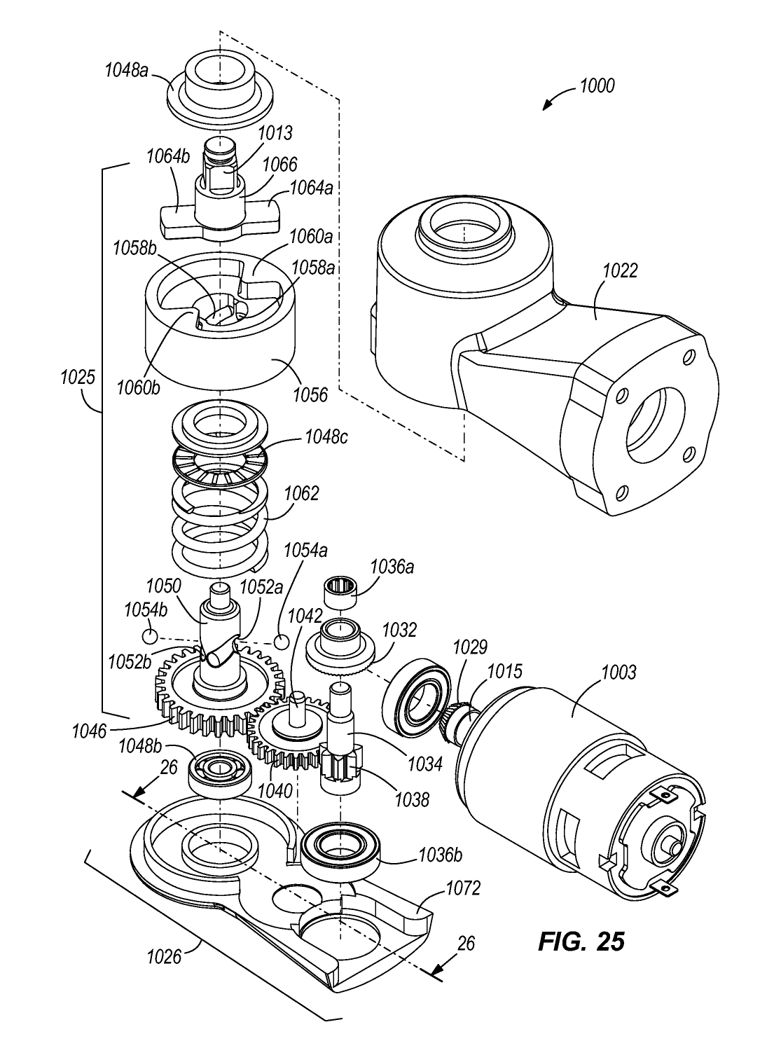

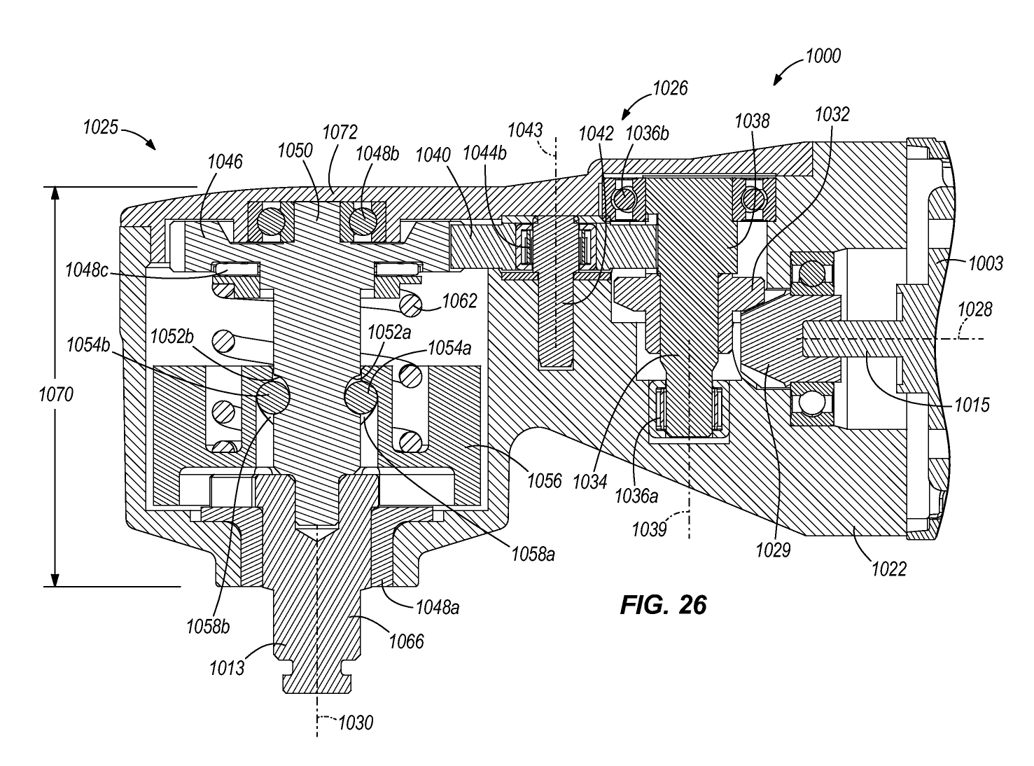

FIGS. 25 and 26 illustrate another alternate embodiment of an angle head 1000 for an impact tool. The angle head work attachment 1000 is coupled to a handle and motor 1003 having a rotor 1015. The illustrated motor 1003 is an electric motor, but any suitable prime mover, such as the pneumatic motor shown in FIGS. 1-16, can be utilized. The angle head work attachment 1000 includes an angle housing 1022 that supports an impact mechanism 1025 and a gear assembly 1026. The rotor 1015 rotates about a first axis 1028. The rotor 1015 includes at least one tooth, and in the illustrated embodiment includes a first bevel gear 1029 coupled thereto. The first bevel gear 1029 actuates the gear assembly 1026 and the impact mechanism 1025 to functionally drive an output, such as a square drive 1013, as shown in FIGS. 25 and 26. The square drive 1013 is rotated about a second axis 1030 which is non-parallel to the first axis 1028. In the illustrated embodiment, the second axis 1030 is perpendicular to the first axis 1028.

The illustrated gear assembly 1026 includes a second bevel gear 1032 that meshingly engages the first bevel gear 1029. The second bevel gear 1032 is coupled to a shaft 1034 for rotation with the shaft 1034. The shaft 1034 is supported in the angle head 1000 by bearings 1036a, 1036b. The shaft 1034 rotates about an axis 1039. The shaft 1034 includes a splined portion 1038 near bearing 1036b. The splined portion 1038 engages a gear, such as a first spur gear 1040, such that rotation of the splined portion 1038 causes rotation of the first spur gear 1040 about an axis 1043. The first spur gear 1040 is coupled to a second shaft 1042 for rotation with the second shaft 1042 about the axis 1043. The second shaft 1042 is supported for rotation with respect to the angle head 1000 by bearings 1044b. The axes 1030, 1039 and 1043 are all substantially parallel to each other and are thus each substantially perpendicular to axis 1028. The first spur gear 1040 is coupled to a second spur gear 1046 to cause rotation of the second spur gear 1046 about the axis 1030. The second spur gear 1046 is coupled to the square drive 1013 through the impact mechanism 1025 for selectively rotating the square drive 1013. The second spur gear 1046 and the square drive 1013 are supported for rotation with respect to the angle head 1000 by bushing 1048a and bearings 1048b and 1048c.

The impact mechanism 1025 can be a standard impact mechanism, such as a Potts mechanism or a Maurer mechanism. The illustrated impact mechanism 1025 includes a cam shaft 1050 coupled to the second spur gear 1046 for rotation with the second spur gear 1046 about the second axis 1030. The illustrated cam shaft 1050 includes opposite cam grooves 1052a, 1052b that define pathways for respective balls 1054a, 1054b. The illustrated impact mechanism 1025 further includes a hammer 1056 that includes opposite cam grooves 1058a, 1058b that are substantially mirror-images of cam grooves 1052a, 1052b. The balls 1054a, 1054b are retained between the respective cam grooves 1052a, 1052b, 1058a, 1058b. The hammer 1056 also includes first and second opposite jaws 1060a, 1060b.

A biasing member, such as an axial compression spring 1062 is positioned between the second spur gear 1046 and the hammer 1056 to bias the hammer 1056 away from the second spur gear 1046. In the illustrated embodiment, the spring 1062 rotates with the hammer 1056 and the bearing 1048c permits the second spur gear 1046 to rotate with respect to the spring 1062. Other configurations are possible, and the illustrated configuration is given by way of example only.

The illustrated square drive 1013 is formed as a single unitary, monolithic piece with first and second jaws 1064a, 1064b to create an anvil 1066. The anvil 1066 is supported for rotation within the angle head 1000 by the bearing or bushing 1048a. The jaws 1060a, 1060b impact respective jaws 1064a, 1064b to functionally drive the square drive 1013 in response to rotation of the second spur gear 1046. The impact cycle is repeated twice every rotation such that the jaws 1060a, 1060b impact the jaws 1064a, 1064b, similar to the embodiment illustrated in FIGS. 24A-24J. The spring 1062 permits the hammer 1056 to rebound after impact and balls 1054a, 1054b guide the hammer 1056 to ride up around the cam shaft 1050, such that jaws 1060a, 1060b are spaced axially from jaws 1064a, 1064b. The jaws 1060a, 1060b are permitted to rotate past the jaws 1064a, 1064b after the rebound. Two such impact cycles occur per rotation of the hammer 1056.

A head height dimension 1070 of the angle head 1000 is illustrated in FIG. 26. The head height dimension 1070 is the axial distance from the top of the angle head 1000 to the beginning edge of the square drive feature 1013 of the anvil 1066. The head height dimension 1070 is reduced so that the angle head 1000 can fit into small spaces. A plate 1072 defines a top of the angle head 1000 and is substantially planar in the illustrated embodiment.

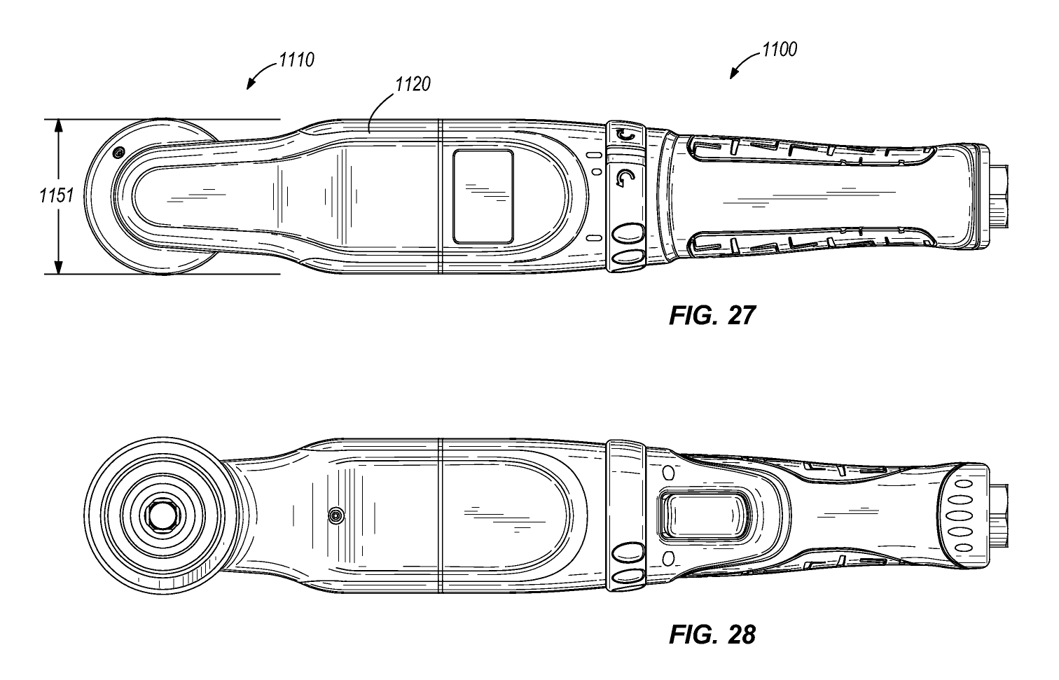

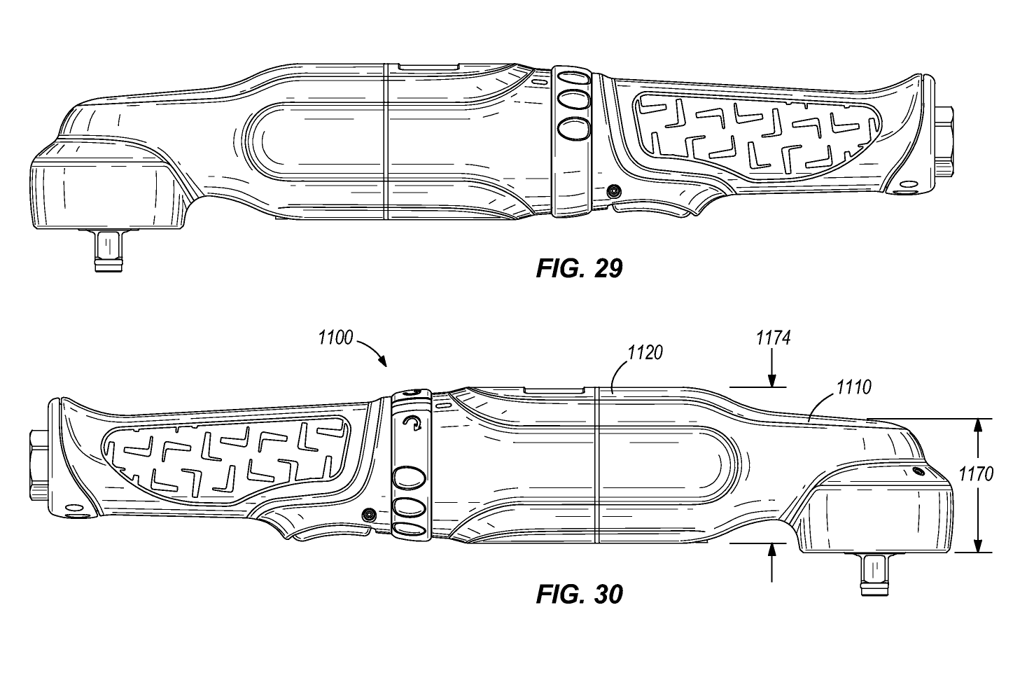

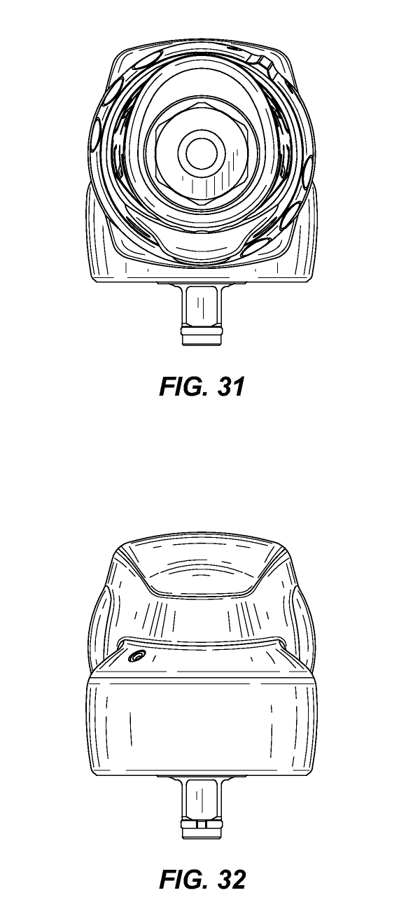

FIG. 27-32 design views to show relative height and width of head and motor of an embodiment of the impact tool 1100. FIG. 27 illustrates an angle head 1110 and a front housing 1120 of the impact tool 1100. In the illustrated embodiment, the angle head 1110 defines a first width 1151 and the front housing 1120 defines a second width, which is substantially equal to the first width 1151. FIG. 30 shows the angle head 1110 having a head height of 1170, and the front housing 1120 having a front housing height 1174. The front housing height 1174 is greater than the head height 1170. In some embodiments, the head height is equal to the front housing height. As shown in FIG. 27-32 the angle head 1110 is substantially contained within a cross-section or an envelope defined by the front housing 1120.

Thus, the invention provides, among other things, an angle impact tool. Various features and advantages of the invention are set forth in the following claims.

What is claimed is:

1. A pneumatic impact tool comprising:
a handle assembly graspable by a user;
a work attachment coupled to the handle assembly;
an inlet permitting air flow into the pneumatic impact tool to drive the impact tool;
an outlet permitting air flow out of the pneumatic impact tool;
a motor assembly functionally positioned between the inlet and the outlet, the motor assembly including a rotor driven by the air flow between the inlet and the outlet, the motor assembly defining a longitudinal motor axis about which the rotor rotates;
an output drive coupled to the motor assembly and selectively rotated in response to rotation of the rotor, the output drive defining a longitudinal output axis about which the output drive rotates, wherein the longitudinal output axis is substantially perpendicular to the longitudinal motor axis; and
an impact mechanism functionally positioned between the motor assembly and the output drive, the impact mechanism driving the output drive with impact forces in response to rotation of the rotor.

2. The pneumatic impact tool of claim 1, further comprising a first bevel gear and a second bevel gear driven by the first bevel gear, the first and second bevel gears functionally positioned between the rotor and the output drive to transmit torque from the rotor to the output drive.

3. The pneumatic impact tool of claim 2, wherein the impact mechanism is positioned between the motor assembly and the first bevel gear, such that the first bevel gear is impactingly driven by the rotor and the impact mechanism.

4. The pneumatic impact tool of claim 2, wherein the impact mechanism is functionally positioned between the second bevel gear and the output drive, such that output drive is driven with impact forces by the second bevel gear and the impact mechanism.

5. The pneumatic impact tool of claim 1, wherein the impact mechanism comprises a hammer coupled to the rotor for rotation with the rotor, and an anvil coupled to the output drive, the hammer operable to impact the anvil to drive the output drive with impact forces in response to rotation of the rotor.

6. The pneumatic impact tool of claim 1, wherein the impact mechanism rotates about an impact axis, the impact axis extending substantially parallel to the longitudinal motor axis.

7. The pneumatic impact tool of claim 1, wherein the impact mechanism rotates about an impact axis, the impact axis extending substantially parallel to the longitudinal output axis.

8. The pneumatic impact tool of claim 1, wherein the work attachment defines a first height and the motor assembly defines a second height, the second height greater than or equal to the first height.

9. A pneumatic impact tool comprising:
a handle assembly graspable by a user;
a work attachment coupled to the handle assembly;
an inlet permitting air flow into the pneumatic impact tool to drive the impact tool;
an outlet permitting air flow out of the pneumatic impact tool;
a motor assembly functionally positioned between the inlet and the outlet, the motor assembly including a rotor driven by the air flow between the inlet and the outlet, the motor assembly defining a longitudinal motor axis about which the rotor rotates;
a valve coupled to the handle assembly, the valve moveable between a first position, in which the rotor is rotated in a first direction, and a second position, in which the rotor is rotated in a second direction, opposite the first direction;
an output drive coupled to the motor assembly and selectively rotated in response to rotation of the rotor, the output drive defining a longitudinal output axis about which the output drive rotates, wherein the longitudinal output axis is substantially perpendicular to the longitudinal motor axis; and
an impact mechanism functionally positioned between the motor assembly and the output drive, the impact mechanism driving the output drive with impact forces in response to rotation of the rotor.

10. The pneumatic impact tool of claim 9, further comprising a first bevel gear and a second bevel gear driven by the first bevel gear, the first and second bevel gears positioned between the rotor and the output drive to transmit torque from the rotor to the output drive.

11. The pneumatic impact tool of claim 10, wherein the impact mechanism is positioned between the motor assembly and the first bevel gear, such that the first bevel gear is driven with impact forces by the rotor and the impact mechanism.

12. The pneumatic impact tool of claim 10, wherein the impact mechanism is positioned between the second bevel gear and the output drive, such that output drive is driven with impact forces by the second bevel gear and the impact mechanism.

13. The pneumatic impact tool of claim 9, wherein the impact mechanism comprises a hammer coupled to the rotor for rotation with the rotor, and an anvil coupled to the output drive, the hammer operable to impact the anvil to drive the output drive with impact forces in response to rotation of the rotor.

14. The pneumatic impact tool of claim 9, wherein the impact mechanism rotates about an impact axis, the impact axis extending substantially parallel to the longitudinal motor axis.

15. The pneumatic impact tool of claim 9, wherein the impact mechanism rotates about an impact axis, the impact axis extending substantially parallel to the longitudinal output axis.

16. The pneumatic impact tool of claim 9, wherein the work attachment defines a first height and the motor assembly defines a second height, the second height greater than or equal to the first height.

17. A pneumatic impact tool comprising:
a handle assembly graspable by a user;
a work attachment coupled to the handle assembly;
an inlet permitting air flow into the pneumatic impact tool to drive the impact tool;
an outlet permitting air flow out of the pneumatic impact tool;
a motor assembly functionally positioned between the inlet and the outlet, the motor assembly including a rotor driven by the air flow between the inlet and the outlet, the motor assembly defining a longitudinal motor axis about which the rotor rotates;
a valve coupled to the handle assembly, the valve moveable between a first position, in which the rotor is rotated in a first direction, and a second position, in which the rotor is rotated in a second direction, opposite the first direction, the valve having a detent mechanism resiliently holding the valve in the first and second positions;
an output drive coupled to the motor assembly and selectively rotated in response to rotation of the rotor, the output drive defining a longitudinal output axis about which the output drive rotates, wherein the longitudinal output axis is substantially perpendicular to the longitudinal motor axis; and
an impact mechanism functionally positioned between the motor assembly and the output drive, the impact mechanism selectively driving the output drive in response to rotation of the rotor, the impact mechanism comprising a hammer coupled to the rotor for rotation with the rotor, and an anvil coupled to the output drive, the hammer operable to impact the anvil to drive the output drive with impact forces in response to rotation of the rotor.

18. The pneumatic impact tool of claim 17, further comprising a first bevel gear and a second bevel gear driven by the first bevel gear, the first and second bevel gears positioned between the rotor and the output drive, wherein the impact mechanism is positioned between the motor assembly and the first bevel gear, such that the first bevel gear is driven with impact forces by the rotor and the impact mechanism, wherein the impact mechanism rotates about an impact axis, the impact axis extending substantially parallel to the longitudinal motor axis.

19. The pneumatic impact tool of claim 17, further comprising a first bevel gear and a second bevel gear driven by the first bevel gear, the first and second bevel gears positioned between the rotor and the output drive, wherein the impact mechanism is positioned between the second bevel gear and the output drive, such that output drive is driven with impact forces by the second bevel gear and the impact mechanism, wherein the impact mechanism rotates about an impact axis, the impact axis extending substantially parallel to the longitudinal output axis.

20. The pneumatic impact tool of claim 17, wherein the work attachment defines a first height and the motor assembly defines a second height, the second height greater than or equal to the first height.
